(19) United States
(12) Patent Application Publication
(10) Pub. No.: US 2025/0089017 A1
(43) Pub. Date: Mar. 13, 2025

(54) METHOD AND APPARATUS FOR PROVIDING CONFIGURATION INFORMATION RELATED TO PAGING IN WIRELESS COMMUNICATION SYSTEM

(71) Applicant: Samsung Electronics Co., Ltd., Gyeonggi-do (KR)

(72) Inventors: Weiwei WANG, Beijing (CN); Hong WANG, Beijing (CN); Lixiang XU, Beijing (CN)

(21) Appl. No.: 18/290,672

(22) PCT Filed: Jul. 22, 2022
(86) PCT No.: PCT/KR2022/010828

§ 371 Date: Jan. 19, 2024

(30) Foreign Application Priority Data
Jul. 22, 2021 (CN) 202110833221.7
Oct. 18, 2021 (CN) 202111210691.4
Jan. 5, 2022 (CN) 202210006666.2

(51) Int. Cl. H04W 68/02; H04W 74/0808

(52) U.S. Cl. CPC H04W 68/02; H04W 74/0808

(57) ABSTRACT

The present disclosure provides a method performed by a gNB-distributed unit (DU) of a base station in a wireless communication system and the gNB-DU, the method comprises receiving, from a gNB-central unit (CU) of the base station, signaling information for paging subgrouping of a user equipment (UE), identifying a subgroup of the UE for the paging subgrouping, based on the signaling information, and transmitting the paging message to the UE which belongs in the subgroup.

### PRIORITY

This application is a National Phase Entry of PCT International Application No. PCT/KR2022/010828, which was filed on Jul. 22, 2022, and claims priority to Chinese Patent Application Nos. 202110833221.7, 202111210691.4, and 202210006666.2, which were filed on Jul. 22, 2021, Oct. 18, 2021, and Jan. 5, 2022, the entire content of each of which is incorporated herein by reference.

### BACKGROUND

### 1. Field

The disclosure relates to the field of communication, and more particularly, to a method for configuring a device and the device.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless communication is one of the most successful innovations in modern history. Recently, the number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### SUMMARY

The present disclosure is to provide a method and apparatus for providing configuration information related to paging in a wireless communication system.

According to an embodiment of the present disclosure, there is provided a method performed by a gNB-distributed unit (DU) of a base station in a wireless communication system, the method comprises receiving, from a gNB-central unit (CU) of the base station, signaling information for paging subgrouping of a user equipment (UE), identifying a subgroup of the UE for the paging subgrouping, based on the signaling information, and transmitting the paging message to the UE which belongs in the subgroup.

According to an embodiment of the present disclosure, there is provided a gNB-DU of a base station in a wireless communication system, the gNB-DU comprises at least one processor configured to receive, from a gNB-CU of the base station, signaling information for paging subgrouping of a UE supporting a paging early indication, identify a subgroup of the UE for the paging subgrouping, based on the signaling information, and transmit a paging message to the UE which belongs in the subgroup.

According to an embodiment of the present disclosure, there is provided a method for receiving a paging message by a UE in a wireless communication system, the method comprises receiving, from a base station, configuration information for paging subgrouping of the UE supporting a paging early indication, identifying a subgroup of the UE for the paging subgrouping, based on the configuration information, and receiving, from the base station, the paging message based on the identified subgroup.

According to an embodiment of the present disclosure, there is provided a UE in a wireless communication system, the UE comprises a transceiver, and a processor configured to receive, through the transceiver from a base station, configuration information for paging subgrouping of the UE supporting a paging early indication, identify a subgroup of the UE for the paging subgrouping, based on the configuration information, and receive, through the transceiver from the base station, the paging message based on the identified subgroup.

According to an embodiment of the present disclosure, there is provided a method for transmitting information related to paging by a base station in a wireless communication system, the method comprises obtaining paging configuration assistance information including information indicating a number of subgroups related to the paging, the paging configuration assistance information required for configuring a transmission of a paging signal, and transmitting, to a user equipment (UE), configuration information related to the paging signal based on the paging configuration assistance information.

According to an embodiment of the present disclosure, there is provided a base station for transmitting information related to paging in a wireless communication system, the base station comprises a transceiver, and a processor configured to obtain paging configuration assistance information including information indicating a number of subgroups related to the paging, the paging configuration assistance information required for configuring a transmission of a paging signal, and transmit, to a user equipment (UE) via the transceiver, configuration information related to the paging signal based on the paging configuration assistance information.

According to an embodiment of the present disclosure, there is provided a method for receiving information related to paging by a user equipment (UE) in a wireless communication system, the method comprises receiving, from a base station, configuration information related to a paging signal to be transmitted based on paging configuration assistance information, and receiving, from the base station, the paging signal based on the received configuration information, wherein paging configuration assistance information including information indicating a number of subgroups related to the paging.

According to an embodiment of the present disclosure, there is provided a user equipment (UE) for receiving information related to paging in a wireless communication system, the UE comprises a transceiver, and a processor configured to receive, via the transceiver from a base station, configuration information related to a paging signal to be transmitted based on paging configuration assistance information, and receive, via the transceiver from the base station, the paging signal based on the received configuration information, wherein paging configuration assistance information including information indicating a number of subgroups related to the paging.

According to an embodiment of the present disclosure, there is provided a method related to paging, including acquiring paging configuration assistance information; transmitting a message including information related to a paging signal based on the paging configuration assistance information.

In an implementation, wherein the paging configuration assistance information includes indication information of the number of subgroups and/or at least one of the following information for each group of UEs of one or more groups of UEs:
identification information of the subgroup;
UE paging probability related information;
UE type related information;
UE movement feature related information;
UE energy feature related information; and
UE capability indication information.

In an implementation, wherein the number of subgroups is one of:
the number of subgroups used in paging via core network based subgrouping method, or
the number of subgroups used for supporting paging via UE ID based subgrouping method,
wherein, the indication information of the number of subgroups further includes identification information of a cell or an area targeted by the number of subgroups, and the area includes one of: a registration area, a tracking area, an RAN notification area, an area covered by the cell, and a coverage area of a base station.

In an implementation, wherein the information related to the paging signal includes information of one or more groups of paging signals, and wherein, for each group of the one or more groups of paging signals, the information related to the paging signal includes at least one of:
a frequency location of the paging signal;
a time location of the paging signal;
a duration occupied by the paging signal;
information of the number of paging occasions corresponding to the paging signal;
energy offset information;
a sequence of the paging signal;
resource mapping mode information;
information of paging signal groups corresponding to a resource of the paging signal;
the number of paging signal groups corresponding to a UE group; and
feature information of the UE group,
wherein the feature information of the UE group includes at least one of:
identification information of the subgroups;
paging probability related information;
UE type related information;
UE movement feature related information;
UE capability indication information; and
energy feature related information.

In an implementation, wherein the acquiring of the paging configuration assistance information includes receiving, by a second node from a first node via a paging configuration message, the paging configuration assistance information at the first node; or receiving, by the second node from the first node via the paging configuration message, the paging configuration assistance information transmitted by the third node to the first node; or acquiring, by the second node, the paging configuration assistance information at the second node itself.

In an implementation, wherein the paging configuration message is one of: an F1 SETUP RESPONSE message, or a GNB-DU CONFIGURATION UPDATE ACKNOWLEDGE message, or a GNB-CU CONFIGURATION UPDATE message, or other messages of an F1 interface, or a W1 SETUP RESPONSE message, or an NG-ENB-DU CONFIGURATION UPDATE ACKNOWLEDGE message, or an NG-ENB-CU CONFIGURATION UPDATE message, or other messages of a W1 interface, or a newly defined message.

In an implementation, wherein the message including information related to a paging signal is transferred via one of: a system message, an radio resource control (RRC) message, or a newly defined message.

In an implementation, the method further includes transmitting, by the second node, the paging configuration assistance information to the first node.

According to an embodiment of the present disclosure, there is provided a method related to paging, including receiving, by a second node, a first paging message including paging transmission assistance information from a first node; and transmitting, by the second node, a paging signal and/or a second paging message to a fourth node based on the first paging message.

In an implementation, wherein the paging transmission assistance information includes at least one of: identification information of a subgroup, first paging assistance information, and information related to a cell.

In an implementation, wherein the first paging assistance information includes at least one of: first UE capability information, UE paging probability related information, UE type related information, UE movement feature related information, UE capability indication information, and UE energy feature related information, wherein the information related to the cell includes information of one or more cells, and for each of the one or more cells, the information related to the cell includes at least one of: identification information of the cell, second paging assistance information, indication information of a most recent visited cell, and identification information of the most recent visited cell, wherein the first UE capability information indicates a supported method of a paging subgroup by a UE, which includes one or more of paging via core network based subgrouping method and paging via UE ID based subgrouping method, wherein the second paging assistance information includes at least one of: identification information of a subgroup, paging probability related information, UE type related information, UE movement feature related information, UE capability indication information, and UE energy feature related information.

In an implementation, wherein a first cell in the information related to the cell is the most recent visited cell; or when the information related to the cell indicates multiple cells, a cell including the second paging assistance information is the most recent visited cell.

In an implementation, wherein the paging transmission assistance information is transferred via one of: a PAGING message of an F1 interface, or other messages of the F1 interface, or a PAGING message of a W1 interface, or other messages of the W1 interface, or a newly defined message.

According to an embodiment of the present disclosure, there is provided a method related to UE access, including receiving, by a second node, access configuration information related to a UE type from a first node; and transmitting, by the second node, the access configuration information to a fourth node.

In an implementation, wherein the access configuration information includes at least one of:
identification information of a cell;
identification information of PLMN supported by the cell;
information of a UE type allowed to access the cell;
information of a UE type not allowed to access the cell;
indication information of cell access;
indication information of single antenna UE access;
indication information of dual antenna UE access.

In an implementation, wherein the access configuration information is transferred via one of the following messages: an F1 SETUP RESPONSE message, or a GNB-DU CONFIGURATION UPDATE ACKNOWLEDGE message, or a GNB-CU CONFIGURATION UPDATE message, or other messages of an F1 interface, or a W1 SETUP RESPONSE message, or an NG-ENB-DU CONFIGURATION UPDATE ACKNOWLEDGE message, or an NG-ENB-CU CONFIGURATION UPDATE message, or a newly defined message.

According to an embodiment of the present disclosure, there is provided a method related to UE access, including determining, by a second node, a UE type based on an access signal received from a fourth node; transmitting, by the second node, indication information of the UE type to a first node; and receiving, by the second node, access configuration information based on the indication information of the UE type from the first node.

In an implementation, wherein the indication information of the UE type is transmitted to the first node via an INITIAL UL RRC MESSAGE TRANSFER message or other messages, and the access configuration information is transmitted to the second node via a DL RRC MESSAGE TRANSFER message or other messages.

According to an embodiment of the present disclosure, there is provided a method related to paging, including acquiring, by a first node, paging configuration assistance information; and transmitting, by the first node, the paging configuration assistance information to a second node or a third node, or transmitting, by the second node, a message including information related to a paging signal to a fourth node based on the paging configuration assistance information.

In an implementation, wherein the first node acquires the paging configuration assistance information by at least one of:
receiving, by the first node, the paging configuration assistance information from the third node;
acquiring, by the first node, the paging configuration assistance information from itself; or
receiving, by the first node, the paging configuration assistance information from the second node.

According to an embodiment of the present disclosure, there is provided a method related to paging, including transmitting, by a first node, a first paging message including paging transmission assistance information to a second node, wherein the paging transmission assistance information includes at least one of: identification information of a subgroup, first paging assistance information, and information related to a cell.

According to an embodiment of the present disclosure, there is provided a method related to UE access, including receiving, by a first node, indication information of a UE type from a second node; and transmitting, by the first node, access configuration information based on the indication information of the UE type to the second node.

According to an embodiment of the present disclosure, there is provided a method related to UE access, including transmitting, by a first node, access configuration information related to a UE type to a second node, wherein the access configuration information includes at least one of:
identification information of a cell;
identification information of PLMN supported by the cell;
information of a UE type allowed to access the cell;
information of a UE type not allowed to access the cell;
indication information of cell access;
indication information of single antenna UE access;
indication information of dual antenna UE access.

According to an embodiment of the present disclosure, there is provided a method related to paging, including transmitting, by a third node, paging configuration assistance information to a first node or receiving, by the third node, the paging configuration assistance information from the first node, wherein the method further includes determining, by the third node, information related to transmission of a paging signal and/or a paging message of a UE based on the paging configuration assistance information.

According to an embodiment of the present disclosure, there is provided a method performed by a sixth node in a wireless communication system, the method including transmitting, by a sixth node, eighth assistance information related to paging of a fourth node to a third node, wherein the eighth assistance information includes at least one of: first identification information of the fourth node used to indicate identification information of the fourth node on an interface between the third node and the sixth node, identification information of an associated node used to indicate a relay terminal to which the fourth node is connected, and first recommendation information including identification information of one or more recommended associated nodes.

According to an embodiment of the present disclosure, there is provided a method performed by a first node in a wireless communication system, wherein the first node communicates with a fourth node via an associated node, the method including receiving, by the first node, first report information related to the fourth node from the associated node; and transmitting, by the first node, ninth assistance information to a sixth node based on the first report information.

In an implementation, wherein the first report information includes at least one of:
second identification information of the fourth node including 5G-S-Temporary Mobile Subscriber Identity 5G-S-TMSI or inactive-radio network temporary identifier I-RNTI,
identification information of a paging subgroup indicating a paging subgroup to which the fourth node belongs,
indication information of a method for determining the paging subgroup, used to indicate one of the following methods: determining a configuration for receiving a paging message based on a configured paging subgroup identification, determining the configuration for receiving the paging message based on identification information of the fourth node,
indication information of a paging method supported by a UE, used to indicate one of the following methods: determining the configuration for receiving the paging message based on the configured paging subgroup identification, and determining the configuration for receiving the paging message based on the identification information of the fourth node, and
wherein the ninth assistance information includes at least one of:
second identification information of the fourth node,
identification information of the associated node, indicating a relay terminal to which the fourth node is connected.

According to an embodiment of the present disclosure, there is provided a communication device, including a transceiver configured to transmit and/or receive signals; a memory configured to store data; and a processor configured to perform control to perform any of the methods according to the embodiments of the present disclosure.

In an implementation, the communication device is a first node, a second node, a third node or a fourth node described below.

### BRIEF DESCRIPTION OF THE DRAWINGS

FIG. 1 is an exemplary system architecture of system architecture evolution (SAE);

FIG. 2 is an exemplary system architecture according to an embodiment of the present disclosure;

FIG. 3 is an example of a base station structure according to an embodiment of the present disclosure;

FIG. 4 is an example of a configuration procedure according to an embodiment of the present disclosure;

FIG. 5 is an example of a configuration procedure according to an embodiment of the present disclosure;

FIG. 6 is an example of a configuration procedure according to an embodiment of the present disclosure;

FIG. 7 is an example of a configuration procedure according to an embodiment of the present disclosure;

FIG. 8 illustrates a simplified block diagram of an example configuration of hardware components of a communication device according to an embodiment of the present disclosure.

### DETAILED DESCRIPTION

The following description with reference to the accompanying drawings is provided to assist in a comprehensive understanding of an embodiment of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. “/” represents “and/or”, for example, “first/second node” represents the first node and the second node, or the first node or the second node.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

In an NR (new radio) system, a UE in different states needs to communicate with a network (e.g., a base station) to different degrees. On the one hand, this mechanism is to ensure that UEs can perform data transmission in time when services arrive, and on the other hand, it is also to save UEs' energy consumption when UE services are not very frequent. In addition, the NR system also needs to allow different types of UEs to access the network. Therefore, NR defines UEs with different capabilities and provides the UEs with different capabilities with network side configurations that match their capabilities.

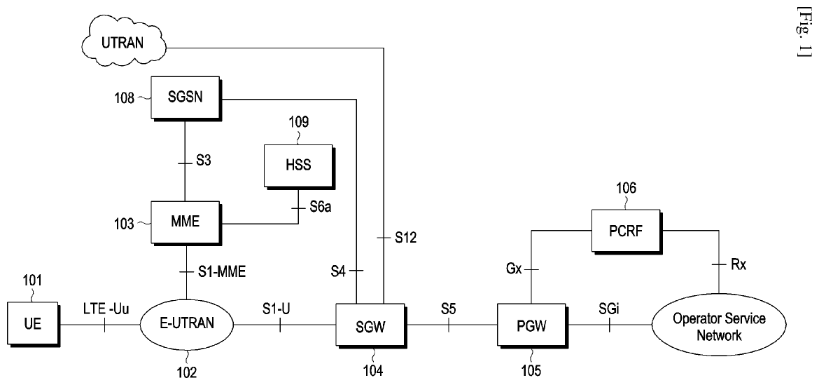

FIGS. 1 to 8 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). user equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting UE information including a current location of the UE, an address of a serving node, UE security information, and packet data context of the UE, etc.

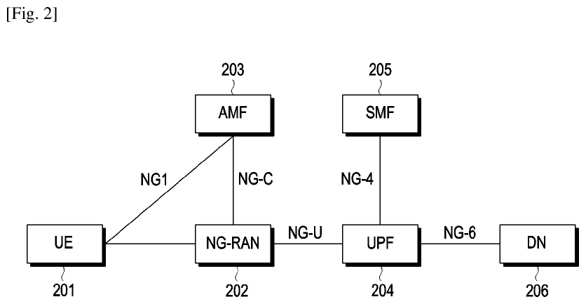

FIG. 2 is an exemplary system architecture 200 according to an embodiment of the present disclosure. Other embodiments of the system architecture 200 can be used without departing from the scope of the present disclosure.

UE 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

In an NR system, in order to support the virtualization of network functions and realize more efficient resource management and scheduling, a base station (gNB/ng-eNB) that provides wireless network interfaces for a terminal (UE) may be further divided into a gNB-CU/ng-eNB-CU (gNB central unit/ng-eNB central unit) 302 and a gNB-DU/ng-eNB-DU (gNB distributed unit/ng-eNB distributed unit) 301 (abbreviated as CU and DU in the present disclosure), as shown in FIG. 3 (a). The gNB-CU 302 has radio resource control (RRC), service data adaptation protocol (SDAP) and packet data convergence protocol (PDCP) protocol layers, etc., and the ng-eNB-CU has RRC and PDCP layers. The gNB-DU/ng-eNB-DU has radio link control protocol (RLC), medium access control (MAC), physical layers, etc. There is a standardized public interface F1 between the gNB-CU 302 and the gNB-DU 301, and there is a standardized public interface W1 between the ng-eNB-CU and the ng-eNB-DU. The F1 interface is divided into a control plane F1-C and a user plane F1-U. A transport network layer of F1-C is based on IP transmission. In order to transport signaling more reliably, an SCTP protocol is added on IP. A protocol of the application layer is F1AP. SCTP may provide reliable application layer message transmission. The transport layer of F1-U is UDP/IP, and GTP-U above UDP/IP is used to carry a user plane protocol data unit PDU. Furthermore, for the gNB-CU, as shown in FIG. 3 (b), the gNB-CU may include a gNB-CU-CP 304 (a control plane part of the central unit of the base station) and a gNB-CU-UP 305 (a user plane part of the central unit of the base station). The gNB-CU-CP 304 contains functions of the control plane of the base station and has RRC and SDAP protocol layers, and the gNB-CU-UP 305 contains functions of the control plane of the base station and has SDAP and PDCP protocol layers. There is a standardized public interface E1 between the gNB-CU-CP 304 and the gNB-CU-UP 305, and the protocol is E1AP. An interface between the control plane part of the central unit of the base station and the distributed unit of the base station is an F1-C interface, that is, a control plane interface of F1, and an interface between the user plane part of the central unit of the base station and the distributed unit of the base station is an F1-U interface, that is, a user plane interface of F1. In addition, in the NR system, a base station accessing a 5G core network that provides E-UTRA user plane and control plane is referred as an ng-eNB. In order to support virtualization, such base station (ng-eNB) may also be further divided into an ng-eNB-CU (gNB central unit/ng-eNB central unit) 307 and an ng-eNB-DU (gNB distributed unit/ng-eNB distributed unit) 306 (abbreviated as CU and DU in the present disclosure), as shown in FIG. 3 (c). The ng-eNB-CU 307 has RRC and PDCP layers. The gNB-DU/ng-eNB-DU 306 has radio link control protocol (RLC), medium access control (MAC), physical layer, etc. There is a standardized public interface W1 between the ng-eNB-CU 307 and the ng-eNB-DU 306. The W1 interface is divided into a control plane W1-C and a user plane W1-U. A transport network layer of W1-C is based on IP transmission. In order to transport signaling more reliably, an SCTP protocol is added on IP. A protocol of the application layer is W1AP. A transport layer of W1-U is UDP/IP, and GTP-U above UDP/IP is used to carry a user plane protocol data unit PDU.

The complexity of the 5G system challenges the energy consumption and complexity of UEs. On the one hand, the design of the 5G system needs to minimize the energy consumption of UEs, and on the other hand, considering the diversity of terminals, the 5G system needs to allow different types of UEs to access. To this end, 3GPP started the research on UE energy saving and the Reduced Capability UE (RedCap UE). UE energy saving involves the energy consumption of a UE in different states (e.g., idle state, connected state, inactive state, etc.). For the idle state or inactive state, the UE is already in a low power consumption stage, but there is still a lot of unnecessary energy consumption. For example, in order to receive a paging signal, the UE needs to receive the paging signal in advance before a paging occasion, and the UE may not receive a paging message in this process, which causes excessive and unnecessary energy consumption. For the reduced capability UE, its device capability is lower than that of normal 5G terminals, so the complexity is low and the energy consumption requirement is higher. When such device accesses the system, how to make such device work well in the 5G network is also an urgent problem to be solved.

In addition, in order to expand a coverage of the base station, the technology of Sidelink relay is proposed in 5G, that is, a UE may access the network through another terminal (relay UE). In this technology, in order to page a UE, the base station may transmit a paging message to the relay terminal, and then the paging message is forwarded by the relay terminal to the UE. In this process, on the one hand, it will lead to excessive energy consumption of the relay terminal, and on the other hand, since the UE has been connected to a relay terminal, the existing mechanism will lead to transmitting of excessive paging messages. Therefore, how to reduce the energy consumption of the relay terminal and transmitting of unnecessary paging messages are also urgent problems to be solved for the sidelink relay technology.

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

Before introducing the specific content, some assumptions and definitions of the present disclosure are given below.

The message names in the present disclosure are only examples, and other message names may also be used.

The “first” and “second”, etc. included in the message names of the present disclosure are only examples of messages, and do not represent a performing order.

In the present disclosure, detailed description of steps irrelevant to the present disclosure is omitted.

In the present disclosure, the steps in each procedure may be performed in combination with each other, and may also be performed individually. The performed steps of each procedure are only examples, and other possible performing orders are not excluded, unless the context clearly specifies otherwise.

In the present disclosure, the base station may be a 5G base station (e.g., gNB, ng-eNB), may also be a 4G base station (e.g., eNB), and may also be other types of access nodes.

In the present disclosure, transmission of data refers to receiving or transmitting of the data.

In the present disclosure, the expression “UE” may be used to represent an access device such as a user terminal in a communication system.

Nodes to which the present disclosure relates:
a first node: for example, a base station, or a central unit of the base station, or a control plane part of the central unit of the base station, such as a gNB, a gNB-CU, a gNB-CU-CP, an ng-eNB, an ng-eNB-CU, and an ng-eNB-CU-CP.
a second node: for example, a distributed unit of a base station, such as a gNB-DU, or an ng-eNB-DU.
a third node: for example, a control unit of a core network, such as an AMF (Access and Mobility Management Function), and an MME (mobility management entity), etc.
a fourth node: for example, a user terminal, such as a UE, or a UE.
a fifth node: for example, a relay terminal, wherein the relay terminal performs data transmission with the above fourth node over sidelink, and the fourth node may perform data transmission with the above first or second node through the fifth node.
a sixth node: for example, a base station, or a central unit of the base station, or a control plane part of the central unit of the base station, wherein the base station to which the sixth node belongs is different from the base station to which the above first and/or second node belongs. In an embodiment, the base station to which the first and/or second node belongs is a base station to which the fourth node is connected (the fourth node initiates, through the fifth node, a connection resume procedure to the base station, such as a serving base station), while the sixth node is a base station to which the fourth node is connected before entering an RRC inactive state (such as a last serving base station).

The present disclosure provides two paging methods:
paging via core network based subgrouping method

The method divides UEs into different paging groups, and configurations used by the different paging groups when receiving paging signals are different. In the method, a core network device (such as an AMF) determines a method of subgroups of the UEs, the subgroup in which the UEs are located, and a total number of the subgroups.
paging via UE ID based subgrouping method

In the method, a base station will transmit a total number of subgroups to a UE, and the UE determines a subgroup in which it is located based on its own identification information (such as a UE ID, a 5G-S-TMSI (Temporary Mobile Subscriber Identity), and an I-RNTI (Inactive-Radio Network Temporary Identifier), etc.), for example, the subgroup of the UE may be obtained by a modulus operation on the identification information based on the total number of the subgroups.

The present disclosure may relate to the following procedures:

A First Aspect: Configuration of a Paging Signal and/or Paging Information.

When a UE is in an idle state or an inactive state, the UE is in a low power consumption stage. A network side may inform the UE to perform data transmission by a way of transmitting a paging message. In this process, in order to receive the paging message, the UE is required to receive the paging message in a configured slot, and the UE is required to wake up before the configured slot (wake up from the low power consumption stage), so as to ensure that the UE can synchronize with the network side and ensure correct reception of the paging message. However, the UE may not receive the paging message for the UE in the configured slot, because the network side will configure multiple UE to receive paging messages in a same slot. If the UE does not receive the paging message for the UE in the configured slot, the UE will experience unnecessary energy consumption in this process (that is, the UE wakes up but does not receive the paging message in the configured slot). In order to solve this technical problem, the present disclosure provides a configuration procedure, which is used to configure transmitting of a paging signal and/or a paging message, to help the UE determine whether there is a paging message to be received in the configured slot, so that the UE is only required to receive the paging message in a slot in which its paging message exists, thereby reducing the energy consumption of the UE.

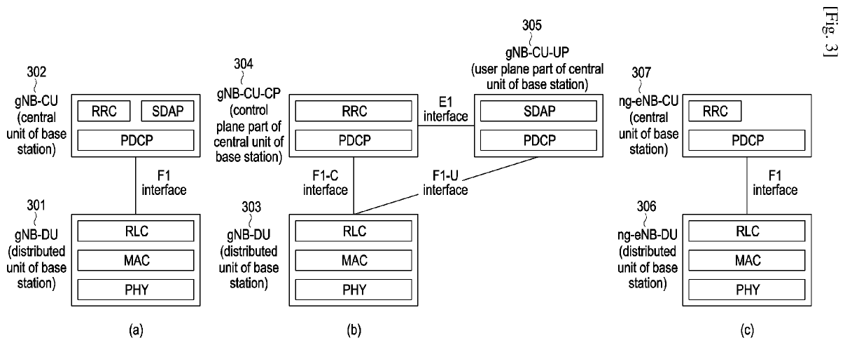

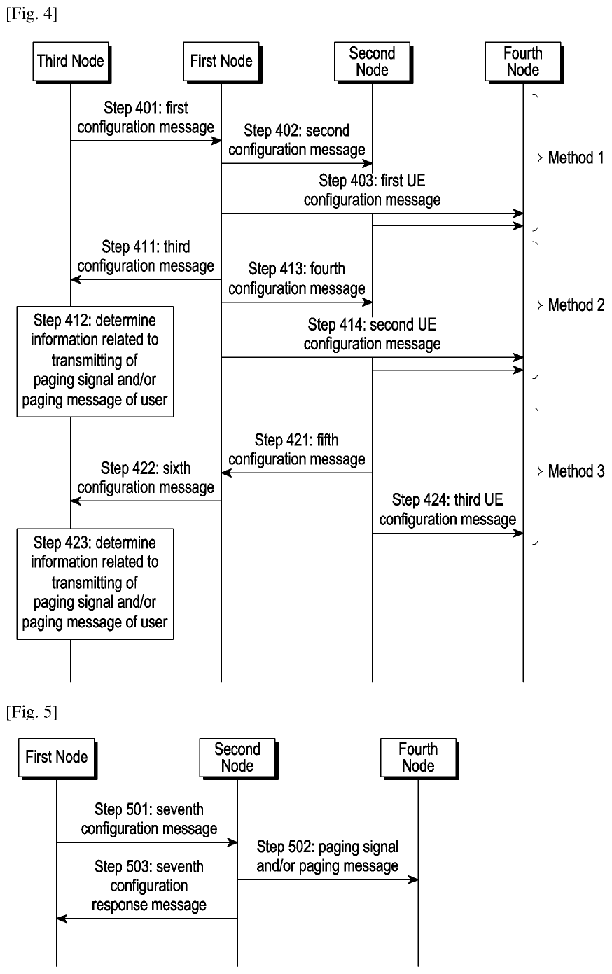

FIG. 4 is an example of a configuration procedure according to an embodiment of the present disclosure.

The nodes to which this procedure relates are the above first/second/third/fourth node, and there are the following several methods, as shown in FIG. 4:

Method 1: assistance information required for configuring transmitting of a paging signal and/or a paging message is provided by a core network.

In the method, a procedure of signaling interaction includes the following steps:
step 401: a third node (e.g. an AMF or an MME) transmits a first configuration message to a first node (e.g. a gNB, a gNB-CU, a gNB-CU-CP, an ng-eNB, an ng-eNB-CU, or an ng-eNB-CU-CP), wherein the first configuration message includes paging configuration information, which is used to provide the assistance information required for configuring the transmitting of the paging signal and/or the paging message to the first node, and the paging configuration information included in the first configuration message includes at least one of the following information A) and B):
A) indication information of the number of subgroups, used to inform the first node of information of the number of subgroups. In an embodiment, the number of subgroups is the number of subgroups set/configured by the third node, which is the number of subgroups used in paging via core network based subgrouping method, and furthermore, it may be applicable to all cells in a registration area. In an implementation, the subgroups are paging subgroups, and based on the information of the number indicated by the indication information of the number of subgroups, the first node may generate configuration information for each paging subgroup; in an embodiment, the number of subgroups indicated by the indication information may be a minimum (or maximum) value among numbers of subgroups supported by all cells in one or more areas (for example, in a case that numbers of subgroups supported by each cell of all cells in one or more areas are not the same as each other, the number of subgroups indicated by the indication information is a maximum or minimum value among multiple different numbers of subgroups supported by the each cell); furthermore, the indication information may also include identification information of one or more areas corresponding to the number of subgroups, and the one or more areas may be at least one of the following types: a registration area, a tracking area, an RAN notification area, an area covered by a cell, and a coverage area of a base station; in an embodiment, if the indication information of the number of subgroups contains the identification information of the one or more areas, the number of subgroups may be a minimum (or maximum) value among numbers of subgroups supported by all cells in areas indicated by the identification information of the one or more areas. Specifically, if the above indication information includes the number of subgroups and identification information of one or more registration areas, the number of subgroups may be a minimum (or maximum) value among numbers of subgroups supported by cells in areas indicated by the identification information of the one or more registration areas; in another embodiment, if the above indication information includes the number of subgroups and identification information of one or more tracking areas, the number of subgroups may be a minimum (or maximum) value among numbers of subgroups supported by cells in areas indicated by the identification information of the one or more tracking areas; in another embodiment, if the above indication information includes the number of subgroups and identification information of one or more RAN notification areas, the number of subgroups may be a minimum (or maximum) value among numbers of subgroups supported by cells in areas indicated by the identification information of the one or more RAN notification areas; in another embodiment, if the above indication information includes the number of subgroups and identification information of one or more cells, the number of subgroups may be a minimum (or maximum) value among numbers of subgroups supported by cells indicated by the identification information of the one or more cells; in another embodiment, if the above indication information includes the number of subgroups and identification information of one or more base stations, the number of subgroups may be a minimum (or maximum) value among numbers of subgroups supported by cells of base stations indicated by the identification information of the one or more base stations.
B) first assistance information, used to help the first node generate configuration information related to the paging signal and/or the paging message. The first assistance information may be given for multiple groups of UEs, respectively, and for a group of UEs, the first assistance information includes at least one of the following information b-1) to b-6):
b-1) first identification information of a subgroup, used to identify a subgroup. In an implementation, the subgroup is a paging subgroup
b-2) first information of a paging probability, used to indicate a probability that a UE is paged. In an embodiment, the paging probability may be a paging probability for the subgroup (i.e., a UE in the subgroup) identified by the above “first identification information of a subgroup”
b-3) first information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “first identification information of a subgroup”
b-4) first information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “first identification information of a subgroup”
b-5) first information of an energy feature indicating a mode of energy supply for the UE, such as plug-in and battery power supply, which may also be referred as Power Profile. In an embodiment, the energy feature information may be an energy feature for the subgroup (i.e., the UE in the subgroup) identified by the above “first identification information of a subgroup”
b-6) UE capability indication information, used to indicate a paging method that can be supported by the UE (e.g., paging via core network based subgrouping method, or paging via UE ID based subgrouping method), and based on the information, it can help a second node determine a configuration for paging a UE (for example, whether to transmit the paging message to the UE based on subgroup identification information contained in the paging message, if the UE supports the paging via core network based subgrouping method, the paging signal may be transmitted to the UE based on the subgroup identification information, and may not otherwise; for another example, whether to support the paging via UE ID based subgrouping method, if so, a subgroup identification is obtained based on a UE identification, and then the paging signal is transmitted in resources corresponding to the subgroup identification)

If the first node is a central unit of a base station or a control plane part of the central unit of the base station, the above procedure may further include:
step 402: the first node transmits a second configuration message to a second node (e.g. gNB-DU or an ng-eNB-DU), wherein the second configuration message includes paging configuration assistance information used to provide information related to configuration of the paging signal and/or the paging message to the second node, and the paging configuration assistance information included in the second configuration message includes at least one of the following information C) and D):
C) indication information of the number of subgroups, used to inform the second node of information of the number of subgroups. In an implementation, the subgroups are paging subgroups, and based on the information of the number, the second node may generate configuration information for each paging subgroup. In an embodiment, the number of subgroups is the number of subgroups set by the third node, which is the number of subgroups used in paging via core network based subgrouping method, and furthermore, it may be applicable to all cells in a registration area. Furthermore, when the second node receives the indication information of the number of subgroups, it will generate the number of subgroups for paging via UE ID based subgrouping method (for example, the number of subgroups used for the paging via UE ID based subgrouping method is not less than or greater than the number of subgroups used for the paging via core network based subgrouping method); in an embodiment, the number of subgroups indicated by the indication information may be a minimum (or maximum) value among numbers of subgroups supported by all cells in one or more areas; furthermore, the indication information may also include identification information of one or more areas corresponding to the number of subgroups, and the one or more areas may be at least one of the following types: a registration area, a tracking area, an RAN notification area, an area covered by a cell, and a coverage area of a base station; in an embodiment, if the identification information of the one or more areas is contained, the number of subgroups may be a minimum (or maximum) value among numbers of subgroups supported by all cells in areas indicated by the identification information of the one or more areas. Specifically, if the above indication information includes the number of subgroups and identification information of one or more registration areas, the number of subgroups may be a minimum (or maximum) value among numbers of subgroups supported by cells in areas indicated by the identification information of the one or more registration areas; in another embodiment, if the above indication information includes the number of subgroups and identification information of one or more tracking areas, the number of subgroups may be a minimum (or maximum) value among numbers of subgroups supported by cells in areas indicated by the identification information of the one or more tracking areas; in another embodiment, if the above indication information includes the number of subgroups and identification information of one or more RAN notification areas, the number of subgroups may be a minimum (or maximum) value among numbers of subgroups supported by cells in areas indicated by the identification information of the one or more RAN notification areas; in another embodiment, if the above indication information includes the number of subgroups and identification information of one or more cells, the number of subgroups may be a minimum (or maximum) value among numbers of subgroups supported by cells indicated by the identification information of the one or more cells; in another embodiment, if the above indication information includes the number of subgroups and identification information of one or more base stations, the number of subgroups may be a minimum (or maximum) value among numbers of subgroups supported by cells of base stations indicated by the identification information of the one or more base stations.
D) second assistance information, used to help the second node generate configuration information related to the paging signal and/or the paging message. The assistance information may be provided for multiple groups of UEs respectively, and for a group of UEs, the second assistance information includes at least one of the following information d-1) to d-6):
d-1) second identification information of a subgroup, used to identify a subgroup. In an implementation, the subgroup is a paging subgroup
d-2) second information of a paging probability, used to indicate a probability that a UE is paged. In an embodiment, the paging probability may be a paging probability for the subgroup (i.e., a UE in the subgroup) identified by the above “second identification information of a subgroup”
d-3) second information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “second identification information of a subgroup”
d-4) second information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “second identification information of a subgroup”
d-5) second information of an energy feature, indicating a mode of energy supply for the UE, such as plug-in and battery power supply, which may also be referred as Power Profile. In an embodiment, the second information of the energy feature may be an energy feature for the subgroup (i.e., the UE in the subgroup) identified by the above “second identification information of a subgroup”
d-6) UE capability indication information, used to indicate a paging method that can be supported by the UE (e.g., paging via core network based subgrouping method, or paging via UE ID based subgrouping method), and based on the information, it can help the second node determine a configuration for paging a UE (for example, whether to transmit the paging message to the UE based on subgroup identification information contained in the paging message, if the UE supports the paging via core network based subgrouping method, the paging signal may be transmitted to the UE based on the subgroup identification information, and may not otherwise; for another example, whether to support the paging via UE ID based subgrouping method, if so, a subgroup identification is obtained based on a UE identification, and then the paging signal is transmitted in resources corresponding to the subgroup identification)
step 403: the first node or the second node transmits a first UE configuration message to a fourth node (e.g. a UE), which includes UE configuration information. In an embodiment, if the first node is a base station, the step 403 is performed after the above step 401, and the first UE configuration message is transmitted by the first node to the fourth node, wherein the UE configuration information in the configuration message is generated based on the information (e.g., paging configuration assistance information) received in the step 401 (for example, the number of configurations of the paging signal and/or the paging message is determined based on the above indication information of the number of subgroups, and a interval/cycle of slots in which the paging signal and/or the paging message is transmitted is determined based on the above first assistance information); in another embodiment, if the first node is the central unit of the base station or the control plane part of the central unit of the base station, the step 403 is performed after the above step 402, and the first UE configuration message is transmitted by the second node to the fourth node, wherein the UE configuration information in the configuration message is generated based on the information (e.g., paging configuration assistance information) received in step 1a-2a. The UE configuration information included in the first UE configuration message may be used to configure transmitting of the paging signal and/or paging information. The UE configuration information included in the first UE configuration message includes at least one of the following information E) and F):
E) first information related to the paging signal, which is information related to the paging signal, wherein the paging signal may be a Wake-up Signaling (WUS), a Group Wake-up Signaling (GWUS), a Paging Early Indication (PEI). Furthermore, there may be one or more paging signals, and when there are multiple paging signals, they may be divided into different groups, and each group of paging signals has corresponding resources. For each group of paging signals, the first information related to the paging signal includes at least one of the following information e-1) to e-10):
e-1) a frequency location of the paging signal, indicating a frequency location where the paging signal is transmitted
e-2) a time location of the paging signal, indicating a time location where the paging signal is transmitted
e-3) a duration occupied by the paging signal indicating a duration occupied by the paging signal, for example, maximum WUS/GWUS/PEI duration
e-4) information of the number of paging occasions (POs) corresponding to the paging signal, indicating the number of paging occasions mapped to a paging signal
e-5) energy offset information, such as power offset, which indicates an offset of energy used by the paging signal relative to other physical signals (e.g., CRS, CSI-RS, SSB, etc.)
e-6) a sequence of the paging signal, indicating a sequence for generating the paging signal
e-7) resource mapping mode information, indicating time/frequency information mapped to paging signal resources
e-8) information of paging signal groups corresponding to a resource of the paging signal indicating paging signal groups corresponding to each paging signal resource
e-9) the number of paging signal groups corresponding to a UE group, indicating the number of paging signal groups corresponding to a group of UEs, wherein features corresponding to the group of UEs may be indicated by the information contained in the above “first assistance information” or “second assistance information”
e-10) feature information of the UE group, indicating features of a group of UEs corresponding to the paging signal, wherein the features may be described by at least one of the following information e-10-1) to e-10-5):
e-10-1) identification information of a subgroup, used to identify a subgroup. In an implementation, the subgroup is a paging subgroup
e-10-2) information of a paging probability, used to indicate a probability that a UE is paged. In an embodiment, the paging probability may be a paging probability for the subgroup (i.e., a UE in the subgroup) identified by the above “identification information of a subgroup”
e-10-3) information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “identification information of a subgroup”
e-10-4) information of a movement feature used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “identification information of a subgroup”
e-10-5) information of an energy feature indicating a mode of energy supply for the UE, such as plug-in and battery power supply, which may also be referred as Power Profile. In an embodiment, the energy feature information may be an energy feature for the subgroup (i.e., the UE in the subgroup) identified by the above “identification information of a subgroup”
F) first information related to the paging message, for example, a slot in which the paging message is transmitted, a DRX configuration for paging, and a cycle for paging.

The beneficial effects of the procedure at least include that the base station can generate the configuration information related to transmitting of the paging signal and/or the paging message based on the assistance information provided by a core network device (e.g., AMF or MME), and transmit the configuration information to the UE. This can help the base station or a distributed unit of the base station reasonably configure the resources related to transmitting of the paging signal and/or the paging message, to avoid wasting and conflicting of the resources; on the other hand, the UE can be configured to receive the paging signal and/or the paging message at the appropriate resources to avoid unnecessary energy consumption. In addition, since the assistance information is generated by the core network device, the beneficial effects of the procedure also include that the core network device can obtain more information from the UE, which is beneficial to generate more accurate and comprehensive assistance information, so that the paging configuration to the UE by the network side can conform to an actual situation of the UE to a greater extent.

In the above procedure, the first configuration message may be an existing message on an NG interface or S1 interface, such as an AMF/MME Configuration Update message, and may also be a newly defined message. The second configuration message may be an F1 SETUP RESPONSE message, or a GNB-DU CONFIGURATION UPDATE ACKNOWLEDGE message, or a GNB-CU CONFIGURATION UPDATE message of an F1 interface, or other messages of the F1 interface, or a W1 SETUP RESPONSE message, or an NG-ENB-DU CONFIGURATION UPDATE ACKNOWLEDGE message, or an NG-ENB-CU CONFIGURATION UPDATE message of a W1 interface, or other messages of the W1 interface, or a newly defined message. The first UE configuration message may be a system message, such as a system message containing system information block 1 (SIB1), may also be an RRC message, and may also be a newly defined message.

Method 2: assistance information required for configuring transmission of a paging signal and/or a paging message is provided by a base station or a central unit of the base station (or a control plane part of the central unit of the base station).

In the method, a procedure of signaling interaction includes the following steps:
step 411: a first node (e.g. a gNB, a gNB-CU, a gNB-CU-CP, an ng-eNB, an ng-eNB-CU, or an ng-eNB-CU-CP) transmits a third configuration message to a third node (e.g. an AMF or an MME), wherein the third configuration message includes paging configuration assistance information, which is used to provide the assistance information required for configuring the transmitting of the paging signal and/or the paging message to the third node, and the paging configuration assistance information included in the third configuration message includes at least one of the following information G) and H):
G) indication information of the number of subgroups used to inform the third node of information of the number of subgroups. In an implementation, the subgroups are paging subgroups, and based on the information of the number, the third node may generate configuration information for each paging subgroup. In an embodiment, the number of subgroups is the number of subgroups set/configured by the first node, and furthermore, it may also contain identification information of a cell for the number of subgroups, wherein the number of subgroups is the number of subgroups used for supporting paging via UE ID based subgrouping method; in another embodiment, the number of subgroups is the number of subgroups set by the first node based on numbers of subgroups configured by cells it controls (such as a maximum value of the numbers of subgroups configured by the cells it controls). After receiving the information, the third node may set the number of subgroups it needs, such as the number of subgroups used in supporting paging via core network based subgrouping method (for example, the number of subgroups used for the paging via UE ID based subgrouping method is not less than or greater than the number of subgroups used for the paging via core network based subgrouping method); in an embodiment, the number of subgroups indicated by the indication information may be a minimum (or maximum) value among numbers of subgroups supported by all cells in one or more areas; furthermore, the indication information may also include identification information of one or more areas corresponding to the number of subgroups, and the one or more areas may be at least one of the following types: a registration area, a tracking area, an RAN notification area, an area covered by a cell, and a coverage area of a base station; in an embodiment, if the identification information of the one or more areas is contained, the number of subgroups may be a minimum (or maximum) value among numbers of subgroups supported by all cells in areas indicated by the identification information of the one or more areas. Specifically, if the above indication information includes the number of subgroups and identification information of one or more registration areas, the number of subgroups may be a minimum (or maximum) value among numbers of subgroups supported by cells in areas indicated by the identification information of the one or more registration areas; in another embodiment, if the above indication information includes the number of subgroups and identification information of one or more tracking areas, the number of subgroups may be a minimum (or maximum) value among numbers of subgroups supported by cells in areas indicated by the identification information of the one or more tracking areas; in another embodiment, if the above indication information includes the number of subgroups and identification information of one or more RAN notification areas, the number of subgroups may be a minimum (or maximum) value among numbers of subgroups supported by cells in areas indicated by the identification information of the one or more RAN notification areas; in another embodiment, if the above indication information includes the number of subgroups and identification information of one or more cells, the number of subgroups may be a minimum (or maximum) value among numbers of subgroups supported by cells indicated by the identification information of the one or more cells; in another embodiment, if the above indication information includes the number of subgroups and identification information of one or more base stations, the number of subgroups may be a minimum (or maximum) value among numbers of subgroups supported by cells of base stations indicated by the identification information of the one or more base stations.
H) third assistance information, used to help the third node generate configuration information related to the paging signal and/or the paging message (for example, determine a paging subgroup of a UE). The assistance information may be given for multiple groups of UEs separately, and for a group of UEs, the third assistance information includes at least one of the following information h1) to h6):
h-1) third identification information of a subgroup, used to identify a subgroup. In an implementation, the subgroup is a paging subgroup
h-2) third information of a paging probability, used to indicate a probability that a UE is paged. In an embodiment, the paging probability may be a paging probability for the subgroup (i.e., a UE in the subgroup) identified by the above “third identification information of a subgroup”
h-3) third information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “third identification information of a subgroup”
h-4) third information of a movement feature used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “third identification information of a subgroup”
h-5) third information of an energy feature indicating a mode of energy supply for the UE, such as plug-in and battery power supply, which may also be referred as Power Profile. In an embodiment, the energy feature information may be an energy feature for the subgroup (i.e., the UE in the subgroup) identified by the above “third identification information of a subgroup”
h-6) UE capability indication information used to indicate a paging method that can be supported by the UE (e.g., paging via core network based subgrouping method, or paging via UE ID based subgrouping method), and based on the information, it can help the third node determine whether to transmit subgroup identification information
step 412: the third node determines information related to transmission of the paging signal and/or the paging message of the UE, for example, a subgroup to which the paging signal and/or the paging message of the UE belongs, the paging probability of the UE, etc. Furthermore, the third node may generate the paging message of the UE based on the information.

If the first node is the central unit of the base station, or the control plane part of the central unit of the base station, after the step 411, it may further include:
step 413: the first node transmits a fourth configuration message to a second node (e.g. gNB-DU or an ng-eNB-DU), wherein the message includes paging configuration assistance information, which is used to provide the assistance information related to the transmitting of the paging signal and/or the paging message to the second node, and the paging configuration assistance information included in the message includes at least one of the following information I) and J):
indication information of the number of subgroups, used to inform the second node of information of the number of subgroups. In an implementation, the subgroups are paging subgroups, and based on the information of the number, the second node may generate configuration information for each paging subgroup. Furthermore, the indication information may also include identification information of a specified cell. In an embodiment, the number of subgroups indicated by the indication information may be a minimum (or maximum) value among numbers of subgroups supported by all cells in one or more areas; furthermore, the indication information may also include identification information of one or more areas corresponding to the number of subgroups, and the one or more areas may be at least one of the following types: a registration area, a tracking area, an RAN notification area, an area covered by a cell, and a coverage area of a base station; in an embodiment, if the indication information of the number of subgroups contains the identification information of the one or more areas, the number of subgroups may be a minimum (or maximum) value among numbers of subgroups supported by all cells in areas indicated by the identification information of the one or more areas. Specifically, if the above indication information includes the number of subgroups and identification information of one or more registration areas, the number of subgroups may be a minimum (or maximum) value among numbers of subgroups supported by cells in areas indicated by the identification information of the one or more registration areas; in another embodiment, if the above indication information includes the number of subgroups and identification information of one or more tracking areas, the number of subgroups may be a minimum (or maximum) value among numbers of subgroups supported by cells in areas indicated by the identification information of the one or more tracking areas; in another embodiment, if the above indication information includes the number of subgroups and identification information of one or more RAN notification areas, the number of subgroups may be a minimum (or maximum) value among numbers of subgroups supported by cells in areas indicated by the identification information of the one or more RAN notification areas; in another embodiment, if the above indication information includes the number of subgroups and identification information of one or more cells, the number of subgroups may be a minimum (or maximum) value among numbers of subgroups supported by cells indicated by the identification information of the one or more cells; in another embodiment, if the above indication information includes the number of subgroups and identification information of one or more base stations, the number of subgroups may be a minimum (or maximum) value among numbers of subgroups supported by cells of base stations indicated by the identification information of the one or more base stations.
J) fourth assistance information, used to help the second node generate configuration information related to the paging signal and/or the paging message. The fourth assistance information may be given for multiple groups of UEs separately, and for a group of UEs, the fourth assistance information at least includes at least one of the following information j-1) to j-6):
j-1) fourth identification information of a subgroup, used to identify a subgroup. In an implementation, the subgroup is a paging subgroup
j-2) fourth information of a paging probability, used to indicate a probability that a UE is paged. In an embodiment, the paging probability may be a paging probability for the subgroup (i.e., a UE in the subgroup) identified by the above “fourth identification information of a subgroup”
j-3) fourth information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “fourth identification information of a subgroup”
j-4) fourth information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “fourth identification information of a subgroup”
j-5) fourth information of an energy feature, indicating a mode of energy supply for the UE, such as plug-in and battery power supply, which may also be referred as Power Profile. In an embodiment, the energy feature information may be an energy feature for the subgroup (i.e., the UE in the subgroup) identified by the above “fourth identification information of a subgroup”
j-6) UE capability indication information, used to indicate a paging method that can be supported by the UE (e.g., paging via core network based subgrouping method, or paging via UE ID based subgrouping method), and based on the information, it can help the second node determine a configuration for paging a UE (for example, whether to transmit the paging message to the UE based on subgroup identification information contained in the paging message, if the UE supports the paging via core network based subgrouping method, the paging signal may be transmitted to the UE based on the subgroup identification information, and may not otherwise; for another example, whether to support the paging via UE ID based subgrouping method, if so, a subgroup identification is obtained based on a UE identification, and then the paging signal is transmitted in resources corresponding to the subgroup identification)

The method may further include the following steps:
step 414: the first node or the second node transmits a second UE configuration message to the fourth node (e.g. a UE). The step 414 may be performed independently of the above step 411 (that is, it is not required to be performed after the step 411). In an embodiment, if the first node is the base station, the step includes transmitting a first UE configuration message to the fourth node by the first node; in another embodiment, if the first node is the central unit of the base station or the control plane part of the central unit of the base station, the step is performed after the above step 1b-1a, and includes transmitting the second UE configuration message to the fourth node by the second node. The second UE configuration message includes UE configuration information, which is used to configure the transmitting of the paging signal and/or paging information. The UE configuration information included in the second UE configuration message includes at least one of the following information K) and L):
K) second information related to the paging signal, which is information related to the paging signal, wherein the paging signal may be a WUS (Wake-up Signaling), a GWUS (Group Wake-up Signaling), a PEI (Paging Early Indication). Furthermore, there may be one or more paging signals, and when there are multiple paging signals, they may be divided into different groups, and each group of paging signals has corresponding resources. For each group of paging signals, the second information includes at least one of the following information k-1) to k-10):
k-1) a frequency location of the paging signal, indicating a frequency location where the paging signal is transmitted
k-2) a time location of the paging signal, indicating a time location where the paging signal is transmitted
k-3) a duration occupied by the paging signal, indicating a duration occupied by the paging signal, for example, maximum WUS/GWUS/PEI duration
k-4) information of the number of paging occasions corresponding to the paging signal, indicating the number of paging occasions mapped to a paging signal
k-5) energy offset information, such as power offset, which indicates an offset of energy used by the paging signal relative to other physical signals (e.g., CRS, CSI-RS, SSB, etc.)
k-6) a sequence of the paging signal, indicating a sequence for generating the paging signal
k-7) resource mapping mode information, indicating time/frequency information mapped to paging signal resources
k-8) information of paging signal groups corresponding to a resource of the paging signal, indicating paging signal groups corresponding to each paging signal resource
k-9) the number of paging signal groups corresponding to a UE group, indicating the number of paging signal groups corresponding to a group of UEs, wherein features corresponding to the group of UEs may be indicated by the information contained in the above “third assistance information” or “fourth assistance information”
k-10) feature information of the UE group, indicating features of a group of UEs corresponding to the paging signal, wherein the features may be described by at least one of the following information k-10-1) to k-10-5):
k-10-1) identification information of a subgroup, used to identify a subgroup. In an implementation, the subgroup is a paging subgroup
k-10-2) information of a paging probability, used to indicate a probability that a UE is paged. In an embodiment, the paging probability may be a paging probability for the subgroup (i.e., a UE in the subgroup) identified by the above “identification information of a subgroup”
k-10-3) information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “identification information of a subgroup”
k-10-4) information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “identification information of a subgroup”
k-10-5) information of an energy feature, indicating a mode of energy supply for the UE, such as plug-in and battery power supply, which may also be referred as Power Profile. In an embodiment, the energy feature information may be an energy feature for the subgroup (i.e., the UE in the subgroup) identified by the above “identification information of a subgroup”
L) second information related to the paging message, for example, a slot in which the paging message is transmitted, a DRX configuration for paging, and a cycle for paging.

The beneficial effects of the procedure include that a core network device (AMF or MME) can generate the configuration information related to the transmitting of the paging signal and/or the paging message based on the assistance information provided by the base station, and transmit the paging message to the UE. This can help the core network device to select an appropriate configuration to trigger the base station to transmit the paging signal and/or the paging message to the UE, so that the energy consumption of the UE in the paging process can be reduced; on the other hand, the UE can be configured to receive the paging signal and/or the paging message at appropriate resources to avoid unnecessary energy consumption. In addition, since the assistance information is generated by the base station or the central unit (or the control plane part of the central unit) of the base station, the beneficial effects of the procedure also include that the base station or the central unit of the base station or the control plane part of the central unit of the base station can generate appropriate division of UE paging groups based on the assistance information, so as to generate appropriate resources for transmitting the paging signal and/or the paging message, thereby avoiding wasting and conflicting of the resources.

In the above procedure, the third configuration message may be an existing message on an NG interface or S1 interface, such as an RAN Configuration Update message, and may also be a newly defined message. The fourth configuration message may be an F1 SETUP RESPONSE message, or a GNB-DU CONFIGURATION UPDATE ACKNOWLEDGE message, or a GNB-CU CONFIGURATION UPDATE message of an F1 interface, or other messages of the F1 interface, or a W1 SETUP RESPONSE message, or an NG-ENB-DU CONFIGURATION UPDATE ACKNOWLEDGE message, or an NG-ENB-CU CONFIGURATION UPDATE message of a W1 interface, or other messages of the W1 interface, or a newly defined message. The second UE configuration message may be a system message, such as a system message containing SIB1, may also be an RRC message, and may also be a newly defined message.

Method 3: assistance information required for configuring transmitting of a paging signal and/or a paging message is provided by a distributed unit of a base station.

In the method, a procedure of signaling interaction includes the following steps:
step 421: a second node (e.g. gNB-DU or an ng-NB-DU) transmits a fifth configuration message to a first node (e.g. a gNB, a gNB-CU, a gNB-CU-CP, an ng-eNB, an ng-eNB-CU, or an ng-eNB-CU-CP), wherein the fifth configuration message includes paging configuration assistance information, which is used to provide the assistance information required for configuring the transmitting of the paging signal and/or the paging message to the first node, and the paging configuration assistance information included in the message includes at least one of the following information M) and N):
M) indication information of the number of subgroups, used to inform the first node of information of the number of subgroups. In an implementation, the subgroups are paging subgroups, and based on the information of the number, the first node may generate configuration information for each paging subgroup, and furthermore, the information may also include identification information of a cell specified by the number of subgroups. In an embodiment, the number of subgroups indicated by the indication information may be a minimum (or maximum) value among numbers of subgroups supported by all cells in one or more areas; furthermore, the indication information may also include identification information of one or more areas corresponding to the number of subgroups, and the one or more areas may be at least one of the following types: a registration area, a tracking area, an RAN notification area, an area covered by a cell, and a coverage area of a base station; in an embodiment, if the indication information of the number of subgroups contains the identification information of the one or more areas, the number of subgroups may be a minimum (or maximum) value among numbers of subgroups supported by all cells in areas indicated by the identification information of the one or more areas. Specifically, if the above indication information includes the number of subgroups and identification information of one or more registration areas, the number of subgroups may be a minimum (or maximum) value among numbers of subgroups supported by cells in areas indicated by the identification information of the one or more registration areas; in another embodiment, if the above indication information includes the number of subgroups and identification information of one or more tracking areas, the number of subgroups may be a minimum (or maximum) value among numbers of subgroups supported by cells in areas indicated by the identification information of the one or more tracking areas; in another embodiment, if the above indication information includes the number of subgroups and identification information of one or more RAN notification areas, the number of subgroups may be a minimum (or maximum) value among numbers of subgroups supported by cells in areas indicated by the identification information of the one or more RAN notification areas; in another embodiment, if the above indication information includes the number of subgroups and identification information of one or more cells, the number of subgroups may be a minimum (or maximum) value among numbers of subgroups supported by cells indicated by the identification information of the one or more cells; in another embodiment, if the above indication information includes the number of subgroups and identification information of one or more base stations, the number of subgroups may be a minimum (or maximum) value among numbers of subgroups supported by cells of base stations indicated by the identification information of the one or more base stations.
N) fifth assistance information, used to help the first node generate configuration information related to the paging signal and/or the paging message (for example, determine a paging subgroup of a UE), or to help the first node provide the assistance information required for configuring the transmitting of the paging signal and/or the paging message to a third node. The fifth assistance information may be given for multiple groups of UEs separately, and for a group of UEs, the fifth assistance information at least includes at least one of the following information n-1) to n-6):
n-1) fifth identification information of a subgroup, used to identify a subgroup. In an implementation, the subgroup is a paging subgroup
n-2) fifth information of a paging probability, used to indicate a probability that a UE is paged. In an embodiment, the paging probability may be a paging probability for the subgroup (i.e., a UE in the subgroup) identified by the above “fifth identification information of a subgroup”
n-3) fifth information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “fifth identification information of a subgroup”
n-4) fifth information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “fifth identification information of a subgroup”
n-5) fifth information of an energy feature, indicating a mode of energy supply for the UE, such as plug-in and battery power supply, which may also be referred as Power Profile. In an embodiment, the energy feature information may be an energy feature for the subgroup (i.e., the UE in the subgroup) identified by the above “fifth identification information of a subgroup”
n-6) UE capability indication information, used to indicate a paging method that can be supported by the UE (e.g., paging via core network based subgrouping method, or paging via UE ID based subgrouping method), and based on the information, it can help the first or third node determine a configuration for paging a UE (for example, whether to transmit the paging message to the UE based on subgroup identification information contained in the paging message, if the UE supports the paging via core network based subgrouping method, the paging signal may be transmitted to the UE based on the subgroup identification information, and may not otherwise; for another example, whether to support the paging via UE ID based subgrouping method, if so, a subgroup identification is obtained based on a UE identification, and then the paging signal is transmitted in resources corresponding to the subgroup identification)
Step 422: the first node transmits a sixth configuration message to the third node, wherein the message includes paging configuration assistance information, which is used to provide the assistance information required for configuring the transmitting of the paging signal and/or the paging message to the third node, and the paging configuration assistance information included in the sixth configuration message includes at least one of the following information O) and P):
O) indication information of the number of subgroups, used to inform the third node of information of the number of subgroups. In an implementation, the subgroups are paging subgroups, and based on the information of the number, the third node may generate configuration information for each paging subgroup. In an embodiment, the number of subgroups is the number of subgroups set by the second node, and furthermore, it may also contain identification information of a cell for the number of subgroups, wherein the number of subgroups is the number of subgroups used for supporting paging via UE ID based subgrouping method; in another embodiment, the number of subgroups is the number of subgroups set by the first node based on numbers of subgroups configured by cells it controls (such as a maximum value of the numbers of subgroups configured by the cells it controls). After receiving the information, the third node may set the number of subgroups it needs, such as the number of subgroups used in supporting paging via core network based subgrouping method (for example, the number of subgroups used for the paging via UE ID based subgrouping method is not less than or greater than the number of subgroups used for the paging via core network based subgrouping method). In an embodiment, the number of subgroups indicated by the indication information may be a minimum (or maximum) value among numbers of subgroups supported by all cells in one or more areas; furthermore, the indication information may also include identification information of one or more areas corresponding to the number of subgroups, and the one or more areas may be at least one of the following types: a registration area, a tracking area, an RAN notification area, an area covered by a cell, and a coverage area of a base station; in an embodiment, if the indication information of the number of subgroups contains the identification information of the one or more areas, the number of subgroups may be a minimum (or maximum) value among numbers of subgroups supported by all cells in areas indicated by the identification information of the one or more areas. Specifically, if the above indication information includes the number of subgroups and identification information of one or more registration areas, the number of subgroups may be a minimum (or maximum) value among numbers of subgroups supported by cells in areas indicated by the identification information of the one or more registration areas; in another embodiment, if the above indication information includes the number of subgroups and identification information of one or more tracking areas, the number of subgroups may be a minimum (or maximum) value among numbers of subgroups supported by cells in areas indicated by the identification information of the one or more tracking areas; in another embodiment, if the above indication information includes the number of subgroups and identification information of one or more RAN notification areas, the number of subgroups may be a minimum (or maximum) value among numbers of subgroups supported by cells in areas indicated by the identification information of the one or more RAN notification areas; in another embodiment, if the above indication information includes the number of subgroups and identification information of one or more cells, the number of subgroups may be a minimum (or maximum) value among numbers of subgroups supported by cells indicated by the identification information of the one or more cells; in another embodiment, if the above indication information includes the number of subgroups and identification information of one or more base stations, the number of subgroups may be a minimum (or maximum) value among numbers of subgroups supported by cells of base stations indicated by the identification information of the one or more base stations.
P) sixth assistance information, used to help the third node generate configuration information related to the paging signal and/or the paging message (for example, determine a paging subgroup of the UE). The sixth assistance information may be given for multiple groups of UEs separately, and for a group of UEs, the sixth assistance information at least includes at least one of the following information p-1) to p-6):
p-1) sixth identification information of a subgroup, used to identify a subgroup. In an implementation, the subgroup is a paging subgroup
p-2) sixth information of a paging probability, used to indicate a probability that a UE is paged. In an embodiment, the paging probability may be a paging probability for the subgroup (i.e., a UE in the subgroup) identified by the above “sixth identification information of a subgroup”
p-3) sixth information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “sixth identification information of a subgroup”
p-4) sixth information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “sixth identification information of a subgroup”
p-5) sixth information of an energy feature, indicating a mode of energy supply for the UE, such as plug-in and battery power supply, which may also be referred as Power Profile. In an embodiment, the energy feature information may be an energy feature for the subgroup (i.e., the UE in the subgroup) identified by the above “sixth identification information of a subgroup”
p-6) UE capability indication information, used to indicate a paging method that can be supported by the UE (e.g., paging via core network based subgrouping method, or paging via UE ID based subgrouping method), and based on the information, it can help the third node determine a configuration for paging a UE (for example, whether to transmit the paging message to the UE based on subgroup identification information contained in the paging message, if the UE supports the paging via core network based subgrouping method, the paging signal may be transmitted to the UE based on the subgroup identification information, and may not otherwise; for another example, whether to support the paging via UE ID based subgrouping method, if so, a subgroup identification is obtained based on a UE identification, and then the paging signal is transmitted in resources corresponding to the subgroup identification)
step 423: the third node (e.g. an AMF or an MME) determines information related to transmitting of the paging signal and/or the paging message of the UE, for example, a subgroup to which the paging signal and/or the paging message of the UE belongs, the paging probability of the UE, etc. Furthermore, the third node may generate the paging message of the UE based on the information.

In addition, the method may further include:
step 424: the second node transmits a third UE configuration message to a fourth node (e.g. a UE), wherein the step 424 may be performed independently from the above steps 421, 422 and 423 (that is, it is not required to be performed after the step 421, 422 and 423). The third UE configuration message includes UE configuration information, which is used to configure the transmitting of the paging signal and/or paging information. The UE configuration information included in the third UE configuration message at least includes at least one of the following information Q) and R):
Q) third information related to the paging signal, which is information related to the paging signal, wherein the paging signal may be a WUS (Wake-up Signaling), a GWUS (Group Wake-up Signaling), a PEI (Paging Early Indication). Furthermore, there may be one or more paging signals, and when there are multiple paging signals, they may be divided into different groups, and each group of paging signals has corresponding resources. For each group of paging signals, the third information at least includes at least one of the following information q-1) to q-10):
q-1) a frequency location of the paging signal, indicating a frequency location where the paging signal is transmitted
q-2) a time location of the paging signal, indicating a time location where the paging signal is transmitted
q-3) a duration occupied by the paging signal, indicating a duration occupied by the paging signal, for example, maximum WUS/GWUS/PEI duration
q-4) information of the number of paging occasions corresponding to the paging signal, indicating the number of paging occasions mapped to a paging signal
q-5) energy offset information, such as power offset, which indicates an offset of energy used by the paging signal relative to other physical signals (e.g., CRS, CSI-RS, SSB, etc.)
q-6) a sequence of the paging signal, indicating a sequence for generating the paging signal
q-7) resource mapping mode information, indicating time/frequency information mapped to paging signal resources
q-8) information of paging signal groups corresponding to a resource of the paging signal, indicating paging signal groups corresponding to each paging signal resource
q-9) the number of paging signal groups corresponding to a UE group, indicating the number of paging signal groups corresponding to a group of UEs, wherein features corresponding to the group of UEs may be indicated by the information contained in the above “fifth assistance information” or “sixth assistance information”
q-10) feature information of the UE group, indicating features of a group of UEs corresponding to the paging signal, wherein the features may be described by at least one of the following information q-10-1) to q-10-5):
q-10-1) identification information of a subgroup, used to identify a subgroup. In an implementation, the subgroup is a paging subgroup
q-10-2) information of a paging probability, used to indicate a probability that a UE is paged. In an embodiment, the paging probability may be a paging probability for the subgroup (i.e., a UE in the subgroup) identified by the above “identification information of a subgroup”
q-10-3) information of a UE type, such as a reduced capability UE (RedCap UE), an eMBB UE, an eMTC UE, a URLLC UE, a multi-SIM card UE, etc. In an embodiment, the UE type may be a type for the subgroup (i.e., the UE in the subgroup) identified by the above “identification information of a subgroup”
q-10-4) information of a movement feature, used to indicate a movement characteristic of the UE, for example, a stationary UE, a moving UE, a fast-moving UE, a medium-speed UE, a low-speed UE and a Nomadic UE. Furthermore, the information may also include information of the UE's motion speed. In an embodiment, the movement feature information may be a movement feature for the subgroup (i.e., the UE in the subgroup) identified by the above “identification information of a subgroup”
q-10-5) information of an energy feature indicating a mode of energy supply for the UE, such as plug-in and battery power supply, which may also be referred as Power Profile. In an embodiment, the energy feature information may be an energy feature for the subgroup (i.e., the UE in the subgroup) identified by the above “identification information of a subgroup”
R) third information related to the paging message, for example, a slot in which the paging message is transmitted, a DRX configuration for paging, and a cycle for paging, etc.

The beneficial effects of the procedure include that a core network device (AMF or MME) or a central unit of the base station (or a control plane part of the central unit of the base station) can generate the configuration information related to the transmitting of the paging signal and/or the paging message based on the assistance information provided by the central unit (or the control plane part of the central unit) of the base station or the distributed unit of the base station, and transmit the paging message to the UE. This can help the core network device or the central unit of the base station (or the control plane part of the central unit of the base station) to select an appropriate configuration to trigger the base station to transmit the paging signal and/or the paging message to the UE, thereby reducing the energy consumption of the UE in the paging process; on the other hand, the distributed unit of the base station can directly configure the UE to receive the paging signal and/or the paging message at appropriate resources, without obtaining the assistance information from the central unit of the base station or the control plane part of the central unit, so that the signaling overhead can be saved. In addition, since the distributed unit of the base station generates the assistance information, the beneficial effects of the procedure also include that the assistance information can be generated based on the resource status of the distributed unit, so that the efficiency of resource usage can be improved.

In the above procedure, the fifth configuration message may be an F1 SETUP REQUEST message, or a GNB-DU CONFIGURATION UPDATE message, or a GNB-CU CONFIGURATION UPDATE ACKNOWLEDGE message of an F1 interface, or other messages of the F1 interface, or a W1 SETUP REQUEST message, or an NG-ENB-DU CONFIGURATION UPDATE message, or an NG-ENB-CU CONFIGURATION UPDATE ACKNOWLEDGE message of a W1 interface, or other messages of the W1 interface, or a newly defined message. The sixth configuration message may be an existing message on an NG interface or S1 interface, such as an RAN Configuration Update message, and may also be a newly defined message. The third UE configuration message may be a system message, such as a system message containing SIB1, may also be an RRC message, and may also be a newly defined message.

It should be noted that although the above three methods are introduced separately, the above three methods can be used in combination with each other. For example, among the above assistance information required for configuring the transmitting of the paging signal and/or the paging message, some information may be provided by Method 1, some information may be provided by Method 2, and some information may be provided by Method 3. Alternatively, a part of the assistance information required for configuring the transmitting of the paging signal and/or the paging message may be provided by the first node, the second node and the third node respectively, or the assistance information may be jointly provided by the first node, the second node and the third node.

### A Second Aspect: A UE Paging Procedure

When a UE is in an idle state or an inactive state, a network side may inform the UE to perform data transmission by a way of transmitting a paging message. In this process, in order to receive the paging message, the UE is required to receive the paging message in a configured slot, and the UE is required to wake up before the configured slot (wake up from the low power consumption stage), so as to ensure that the UE can synchronize with the network side and ensure correct reception of the paging message. However, the UE may not receive the paging message for the UE in the configured slot, because the network side will configure multiple UEs to receive paging messages in the same slot. If the UE does not receive the paging message for the UE in the configured slot, the UE will experience unnecessary energy consumption in this process (such as, the UE does not receive the paging message in the configured slot after waking up). In order to solve this technical problem, the UE may receive some other signals (e.g. a paging signal) before receiving the paging message. These other signals can help the UE determine whether there is a paging message transmitted to the UE in the configured slot, and if so, the UE continues to receive the paging message, and if not, the UE can enter the low power consumption stage. This method can save the UE's energy consumption in the idle state or inactive state. In this process, a base station or a distributed unit of the base station is required to select an appropriate paging signal for a paged UE for transmitting, so that the paged UE can correctly receive a paging signal that helps the UE get the paging message.

In order to solve this technical problem, the present disclosure provides a configuration procedure, which is used to configure transmitting of the paging signal and/or the paging message of the paged UE, to help the UE determine whether there is a paging message to be received in the configured slot, so that the UE is only required to receive the paging message in a slot in which its paging message exists, and the energy consumption of the UE can be reduced.

FIG. 5 is an example of a configuration procedure according to an embodiment of the present disclosure.

The procedure of FIG. 5 relates to a first node and a second node. The first node may be, for example, a central unit of a base station or a control plane part of the central unit of the base station, such as a gNB-CU, a gNB-CU-CP, an ng-eNB, an ng-eNB-CU, and an ng-eNB-CU-CP, and the second node may be, for example, a distributed unit of the base station, such as a gNB-DU, and an ng-eNB-DU. The fourth node may be a UE. The procedure includes the following steps, as shown in FIG. 5:
step 501: the first node transmits a seventh configuration message (e.g., Paging message) to the second node, which is used to help the second node transmit a paging signal and/or a paging message of a UE, wherein the seventh configuration message includes at least one of the following information 1) to 4):
1) identification information of a paged UE
2) a DRX configuration for paging
3) a priority for paging
4) seventh assistance information, which is paging transmission assistance information, and is used to help the second node transmit the paging signal (e.g. WUS, GWUS, PEI, etc.) and/or the paging message. In an embodiment, after receiving the seventh assistance information, optionally, the second node may further determine a configuration of the paging signal and/or paging message that it is required to transmit (e.g., a resource location in which the paging signal is transmitted, a sequence required for transmitting the paging signal, a cycle for transmitting the paging signal, the number of times of transmitting the paging signal, and a resource location in which the paging message is transmitted) based on configuration information (e.g., the related configuration information in the first/second/third UE configuration message obtained based on the process described in FIG. 4, that is, the configuration procedure for the paging signal or paging message in the first aspect above). In an embodiment, the seventh assistance information may be contained in the paging signal or the paging message transmitted by the first node to the second node, and the second node may determine the transmitting of the paging message or the paging signal after receiving the paging signal or the paging message including the seventh assistance information. The seventh assistance information includes at least one of the following information 4-1) or 4-2):
4-1) seventh identification information of a subgroup, for example, a subgroup ID, and a paging subgroup ID. The information is used to indicate a subgroup corresponding to the paging signal and/or the paging message that the second node is required to transmit (or a subgroup corresponding to the paged UE).
4-2) first paging assistance information, such as WUS/GWUS/PEI assistant information, according to which the second node may determine a paging subgroup of the paged UE or help the second node determine a subgroup of the paging signal (e.g., a WUS group, a WUS subgroup, and a PEI subgroup). After receiving the first paging assistance information, the second node may transmit the paging signal and/or the paging message of the UE. The first paging assistance information may include at least one of the following information 4-2-1) to 4-2-5):
4-2-1) first UE capability information, indicating a paging method supported by the UE, wherein a possible method is one or more of the above “paging via core network based subgrouping method” and the above “paging via UE ID based subgrouping method”. Based on the information, the second node may determine whether to determine the transmitting of the paging signal and/or the paging message based on a subgroup allocated by a core network, or determine the transmitting of the paging signal and/or the paging message based on a subgroup determined by a UE identification
4-2-2) information of a paging probability, used to indicate a paging probability of the paged UE
4-2-3) information of a UE type, used to indicate a type of the paged UE, for example, a reduced capability UE, an eMBB UE, an eMTC UE, a URLLC UE, and a multi-SIM card UE, etc.
4-2-4) information of a movement feature, used to indicate a movement characteristic of the paged UE, for example, a stationary UE, a moving UE, a fast-moving UE, a medium-speed UE, a low-speed UE and a Nomadic UE. Furthermore, the information may also include information of the UE's motion speed
4-2-5) information of an energy feature, indicating a mode of energy supply for the paged UE, such as plug-in and battery power supply, etc., which may also be referred as Power Profile
4-3) information related to a cell, used to indicate a cell where the paging signal and/or the paging message of the UE is transmitted, that is, the paging signal and/or the paging message of the UE will only be transmitted in a cell indicated by the information related to the cell. The information related to the cell may include information of one or more cells, and for a cell, the information related to the cell includes at least one of the following information 4-3-1) to 4-3-4):
4-3-1) identification information of the cell
4-3-2) second paging assistance information, such as WUS/GWUS/PEI assistant information, according to which the second node may determine the transmitted paging signal and/or paging message. After receiving the second paging assistance information, the second node may transmit the paging signal and/or the paging message of the UE. In an embodiment, the second paging assistance information may be used in combination with the above “identification information of the cell”, that is, for a cell, if the above “information related to a cell” contains the “identification information of the cell” and the “second paging assistance information”, the second node is required to transmit the paging signal and/or the paging message only in the cell. The second paging assistance information may include at least one of the following information 4-3-2-1) to 4-3-2-5):
4-3-2-1) identification information of a subgroup, indicating a subgroup corresponding to the paging signal and/or the paging message (or a subgroup corresponding to the paged UE)
4-3-2-2) information of a paging probability, used to indicate a paging probability of the paged UE
4-3-2-3) information of a UE type, used to indicate a type of the paged UE, for example, a reduced capability UE, an eMBB UE, an eMTC UE, a URLLC UE, and a multi-SIM card UE, etc.
4-3-2-4) information of a movement feature, used to indicate a movement characteristic of the paged UE, for example, a stationary UE, a moving UE, a fast-moving UE, a medium-speed UE, a low-speed UE and a Nomadic UE, etc. Furthermore, the information may also include information of the UE's motion speed
4-3-2-5) information of an energy feature, indicating a mode of energy supply for the paged UE, such as plug-in and battery power supply, etc., which may also be referred as Power Profile
4-3-3) indication information of a most recent visited cell, used to indicate that a cell indicated by the above “identification information of the cell” is the most recent visited cell of the UE (or referred as a last serving cell, for example, a cell used by the UE before entering an Idle or Inactive state, that is, a last used cell). In an embodiment, the indication information may be explicit indication information; in another embodiment, the indication information may be implicit indication information, for example, when the above “information related to a cell” contains multiple cells, a cell in the first or last position or other specific location is the most recent visited cell of the UE; in another embodiment, for example, when the above “information related to a cell” contains multiple cells, if for one of the cells, the above “second paging assistance information” is also contained, the cell is required to transmit the paging signal and/or the paging message based on the above “second paging assistance information”
4-3-4) identification information of the most recent visited cell, used to indicate the most recent visited cell of the UE. When the information is present, the second node will only transmit the paging signal and/or the paging message in the cell indicated by the identification information
step 502: the second node transmits the paging signal and/or the paging message to a fourth node based on the received information.
step 503: optionally, the second node transmits a seventh configuration response message to the first node, which is used to confirm the seventh configuration message transmitted in the step 501, wherein the step 503 may be performed after step 501, and furthermore, the seventh configuration response message may also include a configuration for transmitting the paging signal and/or the paging message.

The beneficial effects of the procedure include that the second node can determine the configuration for transmitting the paging signal and/or paging information based on the seventh configuration message, and transmit the paging signal and/or the paging message to the UE, so that the UE can determine whether to receive the paging message based on the received paging signal, to help the UE reduce the energy consumption.

The seventh configuration message may be a PAGING message of an F1 interface, or other messages of the F1 interface, or a PAGING message of a W1 interface, or other messages of the W1 interface, or a newly defined message.

In some implementations, the above first aspect and second aspect can be combined with each other, for example, the configuration related to the paging signal and/or the paging message is completed first by the steps in the first aspect; when the network is to page a certain UE, then the transmitting of the paging signal and/or the paging message for the certain UE is completed by the second aspect. Of course, the present disclosure is not limited thereto, and the first aspect and the second aspect can be performed independently.

### A Third Aspect: A UE Access Procedure

When a base station consists of a central unit (or a control plane part of the central unit and a user plane part of the central unit) and a distributed unit, a UE will first access the distributed unit, and then the distributed unit will inform the central unit (or the control plane part of the central unit). The central unit (or the control plane part of the central unit) of the base station will generate some configurations of the UE (e.g., configurations of a PDCP layer) after knowing the UE access, and will also decide whether the UE is allowed to access (for example, decide whether the UE is allowed to access based on a resource status). The technical problem in this process is that the central unit (or the control plane part of the central unit) of the base station cannot know a type of the UE, so that it cannot generate a configuration suitable for the UE or decide the access of the UE based on the type of the UE. Moreover, 3GPP Rel-17 introduces a kind of Reduced Capability UE (RedCap UE), which has lower capabilities than a normal UE, for example, limited storage space, and limited battery energy, etc. Therefore, when the base station communicates with this kind of UE, it is necessary to generate an appropriate configuration or decide whether the UE is allowed to access, based on capabilities of the UE. However, in the prior art, the central unit of the base station cannot know a type of the UE in a UE access process, thus causing the base station to generate an inappropriate configuration or an inappropriate access strategy (for example, allowing an inappropriate UE to access a cell).

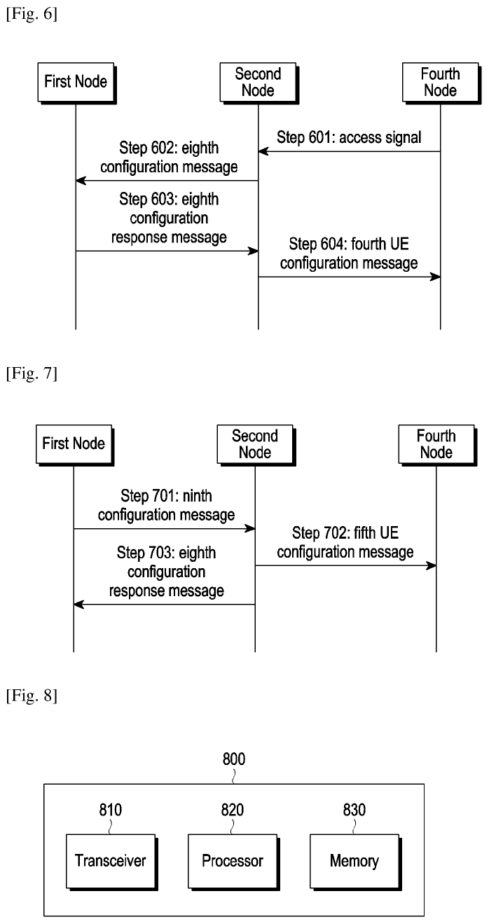

FIG. 6 is an example of a configuration procedure according to an embodiment of the present disclosure.

In order to solve the above technical problem, the present disclosure provides a procedure for the UE to access the cell, which involves a first node (e.g., the central unit of the base station or the control plane part of the central unit of the base station), a second node (e.g., the distributed unit of the base station) and a fourth node (e.g., the UE). The procedure includes the following steps, as shown in FIG. 6:
Step 601: the fourth node transmits an access signal to the second node, wherein the access signal may be Message 1 (e.g., a preamble signal of random access, that is, Preamble) in a random access process, may also be Message 3 in the random access process, and may also be other types of signals.
Step 602: the second node determines a type of a UE based on the access signal received in the step 601, and transmits an eighth configuration message to the first node, wherein the eighth configuration message at least includes one of the following information 5) to 8):
5) indication information of the type of the UE, used to indicate the type of the UE accessing the second node, wherein the type that can be indicated by the indication information may be one of the following types 5-1) to 5-3):
5-1) a reduced capability UE, such as a Reduced Capability UE/device
5-2) a reduced capability UE with single antenna (or single receiving antenna or single transmitting antenna), such as a 1× Reduced Capability UE/device
5-3) a reduced capability UE with dual antennas (or dual receiving antennas or dual transmitting antennas), such as a 2× Reduced Capability UE/device
6) identification information of the UE, such as C-RNTI
7) identification information of a cell to which the UE accesses
8) configuration information of the UE generated by the second node, such as CellGroupConfig
Step 603: the first node transmits an eighth configuration response message to the second node, wherein the eighth configuration response message is used to transmit configuration information of the UE to the second node, and the eighth configuration response message at least includes one of the following information 9) and 10):
9) a container containing a fourth UE configuration message. If the first node decides not to allow the UE to access, the configuration message contained in the container is a reject message (e.g., RRC Reject message), and if the first node decides to allow the UE to access, the first node knows the type of the accessed UE in the step 602, and the configuration message (e.g., RRCSetup message) contained in the container will contain configuration information that matches the type of the UE (for example, a length of PDCP Sequence Number is set to 12 bit)
10) a type of a bearer for transmitting the UE configuration message, such as an SRB ID
step 604: the second node transmits the fourth UE configuration message received in the step 603 to the fourth node (e.g., the UE).

The beneficial effects of the procedure are that the first node can know the type of the UE in the UE access process, so as to determine the configuration that matches the type of the UE (e.g., the configuration of the PDCP layer and the configuration of the PDCP layer of SRB1 used for transmitting an RRC message), or decide whether the UE is allowed to access based on the resource status. This can ensure that the UE can perform data transmission under the configuration matching its type, and can also ensure that access of the network to the UE can be determined as soon as possible, thus reducing unnecessary resource waste.

In the above procedure, the eighth configuration message in the step 602 may be an INITIAL UL RRC MESSAGE TRANSFER message of an F1/W1 interface, and may also be other messages; the eighth configuration response message in the step 603 may be a DL RRC MESSAGE TRANSFER message of the F1/W1 interface, and may also be other messages.

### A Fourth Aspect: A Configuration Procedure of UE Access

3GPP Rel-17 introduces a Reduced Capability UE (RedCap UE). This kind of UE is not able to access all cells. A base station will determine cells that the RedCap UE is allowed to access. In an embodiment, the base station will make a determination based on its own resource status, in another embodiment, the base station will make a determination based on its own capabilities, and in another embodiment, the base station will make a determination based on capabilities of other entities (e.g., an AMF, and a neighbor base station, etc.) to which it is connected. After the base station determines the cells that the RedCap UE is allowed to access, it will inform the UE of the information, so that the UE decides whether to access the cells. When the base station consists of a central unit (or a control plane part of the central unit and a user plane part of the central unit) and a distributed unit, information of cell access (for example, whether a cell allows a UE to access) is transmitted by the distributed unit to the UE (for example, broadcasted to the UE through SIB1), so the information of access to a cell may be configured by an operation, management and administration (OAM) to the distributed unit of the base station. However, in an actual system, access capability of a cell will also change with access of the UE, and this change cannot be accommodated by a configuration of the OAM. A technical problem to be solved by the present disclosure is how to control a type of the UE that the cell allows to access when the access capability of a cell changes.

FIG. 7 is an example of a configuration procedure according to an embodiment of the present disclosure.

In order to solve the above technical problem, the present disclosure gives the following procedure. The procedure involves a first node (e.g., the central unit of the base station or the control plane part of the central unit of the base station), a second node (e.g., the distributed unit of the base station) and a fourth node (e.g., the UE), as shown in FIG. 7:
step 701: the first node transmits a ninth configuration message to the second node, wherein the ninth configuration message is used to configure access information of a cell, and the ninth configuration message includes at least one of the following information:
   identification information of the cell
   identification information of Public Land Mobile Network (PLMN) supported by the cell
   information of a type of a UE allowed to access the cell, for example, a UE with single antenna (or single receiving antenna or single transmitting antenna), a UE with dual antennas (or dual receiving antennas or dual transmitting antennas), a reduced capability (RedCap) UE with single antenna (or single receiving antenna or single transmitting antenna), and a reduced capability UE with dual antennas (or dual receiving antennas or dual transmitting antennas), etc.
   information of a type of a UE not allowed to access the cell, for example, a UE with single antenna (or single receiving antenna or single transmitting antenna), a UE with dual antennas (or dual receiving antennas or dual transmitting antennas), a reduced capability (RedCap) UE with single antenna (or single receiving antenna or single transmitting antenna), and a reduced capability UE with dual antennas (or dual receiving antennas or dual transmitting antennas), etc.
   indication information of cell access, indicating a type of a UE allowed or not allowed to access the cell, for example, a UE with single antenna (or single receiving antenna or single transmitting antenna), a UE with dual antennas (or dual receiving antennas or dual transmitting antennas), a reduced capability (RedCap) UE with single antenna (or single receiving antenna or single transmitting antenna), and a reduced capability UE with dual antennas (or dual receiving antennas or dual transmitting antennas), etc. In an example, the information may be named RedCap Barred, and may include indication information of 1× RedCap Barred and/or indication information of 2× RedCap Barred, wherein the “indication information of 1× RedCap Barred” may indicate whether the UE with single antenna (or single receiving antenna or single transmitting antenna) or the reduced capability (RedCap) UE with single antenna (or single receiving antenna or single transmitting antenna) is allowed to access (for example, allowed to access, not allowed to access, or “1” indicates to allow the access and “0” indicates not to allow the access), and the “indication information of 2× RedCap Barred” may indicate whether the UE with dual antennas (or dual receiving antennas or dual transmitting antennas) or the reduced capability UE with dual antennas (or dual receiving antennas or dual transmitting antennas) is allowed to access (for example, allowed to access, not allowed to access)
   indication information of single antenna UE access, indicating whether the UE with single antenna or the reduced capability UE with single antenna is allowed to access (for example, allowed to access, not allowed to access), in an example, the information may be named 1× RedCap Barred
   indication information of dual antenna UE access indicating whether the UE with dual antennas or the reduced capability UE with dual antennas is allowed to access (for example, allowed to access, not allowed to access), in an example, the information may be named 2× RedCap Barred
step 702: the second node transmits a fifth UE configuration message to the fourth node, wherein the fifth UE configuration message contains configuration information related to a cell access, and the fifth UE configuration message is transmitted based on the information received in the step 701. A UE may determine whether to access the cell after receiving the above fifth UE configuration message.
step 703: optionally, the second node transmits an eighth configuration response message to the first node, wherein the eighth configuration message is used to confirm the information received in the step 701, and the step 703 may occur after the step 701.

The beneficial effects of the above procedure include that the central unit of the base station or the control plane part of the central unit of the base station can determine the access capability of the cell, thereby deciding whether the UE (e.g., the RedCap UE) is allowed to access the cell, and preventing the UE from accessing a cell that cannot accept the UE.

In the above procedure, the ninth configuration message may be an F1 SETUP RESPONSE message, or a GNB-DU CONFIGURATION UPDATE ACKNOWLEDGE message, or a GNB-CU CONFIGURATION UPDATE message of an F1 interface, or other messages of the F1 interface, or a W1 SETUP RESPONSE message, or an NG-ENB-DU CONFIGURATION UPDATE ACKNOWLEDGE message, or an NG-ENB-CU CONFIGURATION UPDATE message of a W1 interface, or a newly defined message.

### A Fifth Aspect: Paging of a UE Through a Relay Terminal

In the aspect, the UE communicates with a network through a relay terminal. In order for a paging message transmitted by a network side to be transmitted to the UE, the relay terminal may receive the paging message belonging to the UE and forward the paging message to the UE. In the prior art, a UE will not receive a paging message for another UE, which will cause a UE that is not in a coverage of a cell to be unable to receive a paging message for it, thus causing the interruption of data transmission. With the introduction of the relay terminal, the UE may obtain the paging message through the relay terminal, which further expands the coverage of the cell and improves the possibility of the UE accessing the network. In order to support the paging of the UE through the relay terminal, the prior art has the following technical problems:
transmitting of unnecessary paging messages: in the prior art, in order to avoid transmitting too many paging messages, for paging initiated by a core network, a base station will provide some recommended cells for a core network device, so that paging messages may only be transmitted in these cells; for paging initiated by the base station, the base station will also select some cells for paging. However, when a UE accesses the network through the relay terminal, the paging message of the UE may only be transmitted to the network that the relay terminal accesses. However, the prior art cannot know the network where the relay terminal to which the UE is connected is located
energy consumption of the relay terminal: in order for the relay terminal to help the UE receive the paging message, the relay terminal is required to monitor the paging message of the UE, which brings extra energy consumption to the relay terminal. The prior art cannot further reduce the energy consumption of the relay terminal

In order to solve the above problems, the present disclosure also provides the following mechanisms. Related nodes include the above first to sixth nodes.

### Mechanism 1: Paging Recommendation Mechanism

When a base station is to release a UE (when the UE enters an idle or inactive state), it will provide some assistance information to a core network device, which can help to select a cell in which a paging message is transmitted. Specifically, the mechanism includes the following step 801:
step 801: a sixth node (e.g., a base station, or a central unit of the base station, or a control plane part of the central unit of the base station to which a fourth node (e.g., a UE) is connected before entering an RRC inactive state (such as a last serving base station)) transmits a first release message to a third node (e.g., an AMF or an MME), which is used to inform release of the fourth node. In an embodiment, the first release message is transmitted after the third node requests the sixth node to release the fourth node. An example of the first release message may use the UE CONTEXT RELEASE COMPLETE message defined in 3GPP TS38.413, and it may also be other messages of an NG interface. The first release message includes eighth assistance information, and the eighth assistance information at least includes one or more of the following information:
   first identification information of the fourth node, which is identification information of the fourth node on an interface between the third node and the sixth node
   identification information of an associated node, indicating a relay terminal (e.g., a fifth node) to which the fourth node is connected, wherein the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information
   first recommendation information, containing identification information of one or more recommended associated nodes (e.g., associated nodes recommended by the sixth node), wherein the recommended associated nodes are relay terminals to which the fourth node may be connected, and the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information

After receiving the above first release message, the third node may determine which base station a paging message should be transmitted to (for example, it should be transmitted to a base station to which a relay terminal indicated by the information is connected) based on the above “identification information of an associated node” and/or “first recommendation information”. Therefore, when paging initiated by a core network is required for the fourth node, the third node may also transmit a paging message of the fourth node to other base stations (e.g., a base station to which a relay terminal indicated by the “identification information of an associated node” is connected and/or a base station with which a relay terminal indicated by the “first recommendation information” is associated). The third node may perform the following step 802:
step 802: the third node transmits a third paging message to the first node, wherein the third paging message at least includes at least one of the following information:
   second identification information of the fourth node, for example, a 5G-S-TMSI, and an I-RNTI (inactive-radio network temporary identifier)
   identification information of an associated node, indicating a relay terminal (e.g., a fifth node) to which the fourth node is connected, wherein the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information
   first recommendation information, containing identification information of one or more recommended associated nodes, wherein the recommended associated nodes are relay terminals to which the fourth node may be connected, and the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information

After receiving the above third paging message, the first node may determine whether the indicated relay terminal is in its coverage based on the above “identification information of an associated node” and/or “first recommendation information”, and if so, it may transmit the paging message of the fourth node to the relay terminal (for example, it may be transmitted through an RRC message of the relay terminal, and may also be transmitted through the paging message of the fourth node).

When paging initiated by the base station is required for the fourth node, the following step 803 may be performed:
Step 803: the sixth node transmits a fourth paging message to the first node (e.g., a base station, or a central unit of the base station, or a control plane part of the central unit of the base station), wherein the fourth paging message is used to inform the first node to transmit a paging message to the fourth node. The fourth paging message at least includes one of the following information:
   second identification information of the fourth node, for example, a 5G-S-TMSI, and an I-RNTI (inactive-radio network temporary identifier)
   identification information of an associated node, indicating a relay terminal (e.g., a fifth node) to which the fourth node is connected, wherein the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information
   first recommendation information, containing identification information of one or more recommended associated nodes, wherein the recommended associated nodes are relay terminals to which the fourth node may be connected, and the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information

After receiving the above fourth paging message, the first node may determine whether the indicated relay terminal is in its coverage based on the above “identification information of an associated node” and/or “first recommendation information”, and if so, it may transmit the paging message of the fourth node to the relay terminal (for example, it may be transmitted through an RRC message of the relay terminal, and may also be transmitted through the paging message of the fourth node).

In addition, the following step 804 may further be performed:
step 804: the first node transmits a paging message of the fourth node to a fifth node (e.g., a relay terminal). The paging message may be transmitted through an RRC message of the fifth node, and then forwarded by the fifth node to the fourth node.

Through the above mechanism, the first node or the third node can know the relay terminal to which the UE is connected or may be connected, so as to transmit the paging message of the UE to these relay terminals, and reduce transmitting of unnecessary paging messages

### Mechanism 2: UE Location Reporting Mechanism

The mechanism is used to inform other base station(s) of a relay terminal to which a UE is connected, so that other base station(s) are only required to transmit paging messages to a base station to which the relay terminal is connected. The mechanism includes the following steps:
step 811: a first node (e.g., a base station, or a central unit of the base station, or a control plane part of the central unit of the base station) transmits a first report message to a sixth node (e.g., a base station, or a central unit of the base station, or a control plane part of the central unit of the base station to which a fourth node (e.g., a UE) is connected before entering an RRC inactive state (such as a last serving base station)), wherein the first report message is used to inform a fifth node (e.g., a relay terminal) to which the fourth node is connected, and the first report message at least includes one of the following information:
   second identification information of the fourth node, for example, a 5G-S-TMSI, and an I-RNTI (inactive-radio network temporary identifier)
   identification information of an associated node, indicating a relay terminal (e.g., a fifth node) to which the fourth node is connected, wherein the identification information may be a 5G-S-TMSI (5G-S-Temporary Mobile Subscriber Identity), may also be an IMSI (International Mobile Subscriber Identity), may also be identification information of the node on an interface, may also be a C-RNTI, and may also be other identification information

After receiving the above first report message, the sixth node can know a connection maintained between the fourth node and a terminal connected to the first node, so that when the sixth node transmits a paging message of the fourth node, the sixth node can transmit the paging message only to the first node, which can save a cell in which the paging message is transmitted.

Furthermore, in order to obtain the second identification information of the fourth node, the following step may further be included:
step 812: the fifth node transmits a second report message to the first node, wherein the message is used to provide information of the fourth node connected to the fifth node to the first node, and the second report message may at least contain at least one of the following information:
   the above “second identification information of the fourth node”, for example, a 5G-S-TMSI, I-RNTI (inactive-radio network temporary identifier)
   identification information of a paging subgroup, indicating a paging subgroup to which the fourth node belongs.
   indication information of a method for determining the paging subgroup, wherein the indicated method may be one of the following methods: 1) determining a configuration for receiving a paging message (e.g., a resource for receiving the above paging early indication) based on a configured paging subgroup identification, and 2) determining the configuration for receiving the paging message (e.g., the resource for receiving the above paging early indication) based on identification information of the fourth node
   indication information of a paging method supported by a UE, wherein the indicated method may be one of the following methods: 1) determining the configuration for receiving the paging message (e.g., the resource for receiving the above paging early indication) based on the configured paging subgroup identification, and 2) determining the configuration for receiving the paging message (e.g., the resource for receiving the above paging early indication) based on the identification information of the fourth node

Furthermore, in order to provide information related to the fourth node to the fifth node, the following step 813 may further be included before the step 812:
step 813: the fourth node transmits a third report message to the fifth node, wherein the message is used to provide information related to paging of the fourth node to the fifth node, and the third report message at least includes one of the following information:
   the above “second identification information of the fourth node”, for example, a 5G-S-TMSI, I-RNTI (inactive-radio network temporary identifier)
   identification information of a paging subgroup, indicating a paging subgroup to which the fourth node belongs.
   indication information of a method for determining the paging subgroup, wherein the indicated method may be one of the following methods: 1) determining a configuration for receiving a paging message (e.g., a resource for receiving the above paging early indication) based on a configured paging subgroup identification, and 2) determining the configuration for receiving the paging message (e.g., the resource for receiving the above paging early indication) based on identification information of the fourth node
   indication information of a paging method supported by a UE, wherein the indicated method may be one of the following methods: 1) determining the configuration for receiving the paging message (e.g., the resource for receiving the above paging early indication) based on the configured paging subgroup identification, and 2) determining the configuration for receiving the paging message (e.g., the resource for receiving the above paging early indication) based on the identification information of the fourth node

The effect of receiving the above message is that, on the one hand, the fifth node can generate the information in the step 812, and on the other hand, the fifth node can determine the configuration for receiving the paging message of the fourth node based on the received information, for example, determining the resource for receiving the above paging early indication.

Through the above mechanism, the sixth node can know the relay terminal to which the UE is connected, so as to transmit the paging message of the UE to the base station to which the relay terminal is connected, and reduce transmitting of unnecessary paging messages. At the same time, the relay terminal can receive the paging message of the UE based on the configuration of the paging message of the UE (e.g., the resource for receiving the above paging early indication).

FIG. 8 illustrates a simplified block diagram of an example configuration of hardware components of a communication device 800 according to various embodiments of the present disclosure, and the communication device may be configured to implement any one or more of the methods according to various embodiments of the present disclosure. Therefore, it should be understood that the communication device 800 may be, for example, a first node, a second node, a third node, and a fourth node/UE described in the present disclosure, or a part thereof.

As shown in FIG. 8, the communication device 800 includes a transceiver 810, a processor 820 and a memory 830. The communication device of FIG. 8 may be one of network entities described in the embodiments of FIGS. 1 to 8.

The transceiver 810 is configured to receive and/or transmit signals.

The processor 820 is operatively connected to the transceiver 810 and the memory 830. The processor 820 may be implemented as one or more processors for operating according to any one or more of the methods described in various embodiments of the present disclosure. When the communication device of FIG. 8 is a base station, the transceiver 810 may include a communication interface for communicating with a network entity of the core network and a transmitter and/or a receiver for communicating with the UE through a radio network. When the communication device of FIG. 8 is the UE, the transceiver 810 may include a transmitter and/or a receiver for communicating with the base station through the wireless network. When the communication device of FIG. 8 is a network entity of the core network, the transceiver may include a communication interface for communicating with the base station or other network entity in the core network.

The memory 830 is configured to store computer programs and data. The memory 830 may include a non-transitory memory for storing operations and/or code instructions executable by the processor 820. The memory 830 may include non-transitory programs and/or instructions readable by the processor, which, when executed, cause the processor 820 to implement the steps of any one or more of the methods according to various embodiments of the present disclosure. The memory 830 may further include a random access memory or buffer(s) to store intermediate processing data from various functions performed by the processor 820.

Those of ordinary skill in the art will recognize that the description of the methods of the present disclosure is only illustrative and is not intended to be limited in any way. Other embodiments will be readily apparent to those of ordinary skill in the art having the benefit of the present disclosure.

For the sake of clarity, not all conventional features of the implementations of the methods and devices of the present disclosure are shown and described. Of course, it should be understood that in the development of any such actual implementations of the methods and devices, in order to achieve the specific goals of the developers, such as conforming to the constraints related to applications, systems, networks and businesses, many implementation-specific decisions may need to be made, and these specific goals will vary with different implementations and developers.

The modules, processing operations and/or data structures described according to the present disclosure may be implemented using various types of operating systems, computing platforms, network devices, computer programs and/or general-purpose machines. In addition, those skilled in the art will recognize that less general-purpose devices such as hard-wired devices, Field Programmable Gate Array (FPGA), Application Specific Integrated Circuits (ASIC), etc. may also be used. In the case that a method including a series of operations and sub-operations is implemented by a processor, computer or machine, and those operations and sub-operations may be stored as a series of non-transitory code instructions readable by the processor, computer or machine, they may be stored on a tangible and/or non-transitory medium.

The modules of the methods and devices described herein may include software, firmware, hardware or any combination(s) of software, firmware or hardware suitable for the purpose described herein.

In the methods described herein, various operations and sub-operations may be performed in various orders, and some of the operations and sub-operations may be optional.

Although the foregoing disclosure of the present application has been made by non-limiting illustrative embodiments, these embodiments may be arbitrarily modified within the scope of the appended claims without departing from the spirit and nature of the present disclosure.

1-15. (canceled)

16. A method performed by a gNB-distributed unit (DU) of a base station in a wireless communication system, the method comprising:
receiving, from a gNB-central unit (CU) of the base station, signaling information for paging subgrouping of a user equipment (UE);
identifying a subgroup of the UE for the paging subgrouping, based on the signaling information; and
transmitting the paging message to the UE which belongs in the subgroup.

17. The method of claim 16, wherein the signaling information includes at least one of a subgroup ID corresponding to the subgroup of the UE, UE capability information supporting the paging subgrouping, and cell information indicating a last used cell of the UE.

18. The method of claim 16, wherein the paging subgrouping includes UE ID based paging subgrouping, and the UE supports a paging early indication, and
wherein identifying a subgroup of the UE further comprises determining a subgroup ID of the UE for the paging subgrouping, based on a UE ID of the UE and a total number of subgroups.

19. The method of claim 16, further comprising identifying, by the gNB-DU, that the UE accessing the gNB-DU in a random access procedure is a reduced capability UE; and
transferring, to the gNB-CU, information indicating that the UE accessing the gNB-DU is the reduced capability UE.

20. The method of claim 19, further comprising receiving, from the gNB-CU receiving the transferred information, a radio resource control (RRC) setup message by the gNB-DU.

21. A gNB-distributed unit (DU) of a base station in a wireless communication system, the gNB-DU comprising:
at least one processor configured to:
receive, from a gNB-central unit (CU) of the base station, signaling information for paging subgrouping of a user equipment (UE) supporting a paging, from a gNB-ce,
identify a subgroup of the UE for the paging subgrouping, based on the signaling information, and
transmit a paging message to the UE which belongs in the subgroup.

22. The gNB-DU of claim 21, wherein the signaling information includes at least one of a subgroup ID corresponding to the subgroup of the UE, UE capability information supporting the paging subgrouping, and cell information indicating a last used cell of the UE.

23. The gNB-DU of claim 21, wherein the paging subgrouping includes UE ID based paging subgrouping, and the UE supports a paging early indication, and
wherein identifying a subgroup of the UE further comprises determining a subgroup ID of the UE for the paging subgrouping, based on a UE ID of the UE and a total number of subgroups.

24. The gNB-DU of claim 21, wherein the at least one processor is further configured to:
identify that the UE accessing the gNB-DU in a random access procedure is a reduced capability UE; and
transfer, to the gNB-CU, information indicating that the UE accessing the gNB-DU is the reduced capability UE.

25. The gNB-DU of claim 24, wherein the at least one processor is further configured to receive, from the gNB-CU receiving the transferred information, a radio resource control (RRC) setup message by the gNB-DU.

26. A method for receiving a paging message by a user equipment (UE) in a wireless communication system, the method comprising:
receiving, from a base station, configuration information for paging subgrouping of the UE supporting a paging early indication;
identifying a subgroup of the UE for the paging subgrouping, based on the configuration information; and
receiving, from the base station, the paging message based on the identified subgroup.

27. The method of claim 26, wherein the paging subgrouping includes UE ID based paging subgrouping, and
wherein identifying a subgroup of the UE further comprises determining a subgroup ID of the UE for the paging subgrouping, based on a UE ID of the UE and a total number of subgroups.

28. The method of claim 27, wherein the configuration information includes information indicating the total number of subgroups.

29. The method of claim 26, wherein the UE receives the paging message in a last used cell of the UE.

30. The method of claim 26, further comprising performing a random access procedure for accessing the base station by the UE which is a reduced capability UE.

31. A user equipment (UE) in a wireless communication system, the UE comprising:
a transceiver; and
a processor configured to:
receive, through the transceiver from a base station, configuration information for paging subgrouping of the UE supporting a paging early indication,
identify a subgroup of the UE for the paging subgrouping, based on the configuration information, and
receive, through the transceiver from the base station, the paging message based on the identified subgroup.

32. The UE of claim 31, wherein the paging subgrouping includes UE ID based paging subgrouping, and
wherein the processor is further configured to determine a subgroup ID of the UE for the paging subgrouping, based on a UE ID of the UE and a total number of subgroups.

33. The UE of claim 32, wherein the configuration information includes information indicating the total number of subgroups.

34. The UE of claim 31, wherein the UE receives the paging message in a last used cell of the UE.

35. The UE of claim 31, wherein the processor is further configured to perform a random access procedure for accessing the base station by the UE which is a reduced capability UE.
